(19) United States
(12) Patent Application Publication
(10) Pub. No.: US 2014/0164073 A1
(43) Pub. Date: Jun. 12, 2014

(54) Systems and Methods for Analyzing Recognition Data for Talent and Culture Discovery

(71) Applicants: Eric Mosley, Wellesley, MA (US); Grant Beckett, Wellesley, MA (US); Julie Sargent, Clinton, MA (US); Jonathan Hyland, Dublin (IE)

(72) Inventors: Eric Mosley, Wellesley, MA (US); Grant Beckett, Wellesley, MA (US); Julie Sargent, Clinton, MA (US); Jonathan Hyland, Dublin (IE)

(73) Assignee: Globoforce Limited

(21) Appl. No.: 13/708,707

(22) Filed: Dec. 7, 2012

(51) Int. Cl. G06Q 10/06

(52) U.S. Cl. CPC G06Q 10/06398
USPC 705/7.42

(57) ABSTRACT

Embodiments of the invention provide tools for creating recognition moments in real-time and generating recognition network graphs that represent the recognition connections throughout organizations. Recognition network graphs are utilized to transmit recognition announcements throughout the organization, which, in turn, promotes a positive organizational climate and the values of the organization and aides managers in determining employees who are critical to the prior and future success of their business initiatives even when those employees are not within their traditional organizational hierarchies or span of control. The recognition network graph highlights connections between employees that are not self-evident within traditional organization charts. The recognition network graph may depict how business objectives are achieved via both formal and informal employee connections. Embodiments further provide managers and others with dynamic user interfaces containing recognition network graphs, reports and other analytics that facilitate the assessment of employee performance, influence, impact and other employee metrics.

### RELATED APPLICATIONS

This application hereby claims priority to and incorporates by reference U.S. Provisional Application Ser. No. 61/568,999 filed on Dec. 9, 2011.

### FIELD OF THE INVENTION

The present invention relates generally to systems and methods for promoting recognition within an organization and more particularly to systems and methods for analyzing recognition data along with company organizational data to generate a recognition social graph and other employee talent assessment graphs and analytics.

### BACKGROUND OF THE INVENTION

The concept of providing employees with rewards and recognition through formal programs is known in the art. Employees may be recognized by their employers through “point-in-time” performance reviews or through traditional recognition programs. Typical rewards may range from stock options and bonuses, to “employee of the month” plaques on the wall of employee break-rooms, for example. While these programs do provide employees with feedback from time-to-time, these solutions are deeply flawed and provide limited benefits.

For instance, performance reviews are a traditional part of talent assessment and typically involve aggregating comments from managers according to an arbitrary calendar demarcation (i.e., bi-annually). An employee's direct manager may review the aggregated comments and provide the employees with the results, often by analyzing both positive and negative contributions of an employee.

However, these performance reviews are flawed as they fail to provide an accurate, ongoing assessment of an employee's potential, performance, and value to the company. For one, many of these reviews are provided by a limited subset of the company population. The employee's true impact on the organization, including his or her impact on other employees, managers, divisions, groups or teams are typically not collected. Instead, reviews are typically given only by direct-managers of employees. As a result, only a limited portion of the employee's impact may be realized through the collection of comments provided by only the employee's direct supervisor. Therefore, the data collected and relied upon may not adequately provide a meaningful and complete picture in determining the employee's performance and impact with respect to the company.

Furthermore, performance reviews are often entirely based on the subjective opinions of the managers, which may also vary from manager to manager. Such opinions, while important, may be inaccurate or flawed. Moreover, the comments and feedback collected from the performance reviews are limited to a single point in time. Managers and other reviewers are often asked to provide their opinion of the employee's performance once per review period. Therefore, as is the usual case, managers are asked once, or at most twice a year, to review the employee's work from the past 6 to 12 months. While such feedback theoretically should provide data of the employee's work for the entire review period, the nature of the single point-in-time review ultimately results in the review of the employee's performance only at the particular review date, potentially ignoring the employee's performance for much of the review period.

By the nature of these reviews, it is also difficult for a manager to recall, much less analyze, the performance of the employee over such a long period and from so far in the past. Yet, these performance reviews are dependent on such subjective and potentially inaccurate data. Even if the reviews are assumed to be accurate at the time of writing to cover the entire review period, it often takes weeks or months for feedback to be provided to the employee. As a result, by the time the employee receives recognitions or comments, the feedback received is likely out of date.

Point-in-time performance reviews also limit employers from reviewing the employees at any desired time. Instead, employers must often wait until the end of each review period, after review forms are provided to managers and after the reviews have been completed and analyzed—a formalistic process that can take months. Accordingly, employers can only determine an employee's performance and impact on the company once a review period, e.g., once every year.

Like performance reviews, companies also often utilize recognition programs in an attempt to reward employees performance, such as by rewarding standout employees with a plaque or a special bonus quarterly or annually. However, like performance reviews, these recognition programs also provide limited benefits. For instance, these programs are typically limited to only managers or senior managers nominating their employees for quarterly or annual awards whereby the winners are selected by a committee with only a small percentage of the entire workforce (e.g., less than 10%) receiving any type of recognition award on an annual basis. By failing to provide full participation to the workforce with a free flow of recognition moments, these programs fail to identify relationships among employees and various other organizational members and fail to fully incentivize beneficial employee actions.

Furthermore, typical employee recognition programs fail to capture all of an employee's “recognition moments,” such as those opportunities to “recognize” an employee's contributions or efforts and improve the organizational climate and culture, as well as promote the employee's actions that initiated the recognition moment. Employees are unlikely to receive recognition for actions and performance that otherwise should be recognized, even if in minor ways. Indeed, the typical recognition programs provide a minimal amount of recognition and fail to, therefore, drive improvement in behavior and culture across the entire workforce.

Recognition programs and point-in-time reviews also provide employers with a very little data that describes employee performance, impact and potential. While reviews, plaques and bonuses provide employers with some insight into the employee's impact, this limited set of data fails to capture a plethora of other meaningful metrics of the employees at the individual, team and organizational level. Even when data is provided, it is often difficult to understand and it fails to provide a comprehensive picture of the employee's performance. Moreover, they fail to provide employers with insight into the performance, impact and potential of each employee with respect to other employees within the organization. Critical talent information is extremely important to a business's success, and holds great value. Key understandings about employees at large companies, such as their likelihood of leaving the company, their engagement in their work, their connectedness to others in the organization, their readiness for promotion and other information, have quantifiable value. For example, the costs of turnover are usually estimated at 30-50 percent of the annual salary of entry-level employees, 150 percent for middle level employees, and up to 400 percent for specialized, high-level employees. However, currently available recognition programs and point-in-time reviews do not provide employers with such important information.

Employee recognition programs and point-in-time reviews can be an important aspect of creating a positive organizational climate and organizational culture and for promoting and encouraging effective skills, habits and behaviors by an employee. Employee recognition programs may deliver the most impact to the culture of an organization and overall employee engagement in the business of the organization when all employees (not just managers) are encouraged to recognize other employee's work efforts and their demonstration of the behavioral values of the company. A well designed and implemented program may allow for any employee to recognize any other employee with little corporate friction (e.g., by not requiring multiple levels of approval or by not limiting the number of award winners by committee selection). Yet, current solutions fail to fully provide companies with these potential benefits.

### SUMMARY OF THE INVENTION

Accordingly, there is a need for an employee recognition system that can improve upon the deficiencies of currently utilized employee recognition programs and point-in-time reviews currently utilized as a means to collect, analyze and provide data on employee performance, impact, and potential. There is a need to provide all employees and supervisors, alike, with a solution that can allow for the recognition of beneficial actions and the impact of employees in “real-time,” such that employees may be awarded for actions that align with corporate goals and values. Recognitions should not be limited to those within an employee's team or division, as a solution should recognize that employees may have substantial impact on the company in a number of facets and manners, including impact on other teams and divisions, or even on other organizations. Nor should recognitions be limited to a single point-in-time, but rather, should be available at all times, providing employees with incentive to perform and improve the company in accordance with the company's goals and, in return, be recognized at any time of the year. As a further benefit, the data collected may more accurately reflect the employee's impact on the company.

At the same time, there is a need to automatically collect and analyze these recognition moments and provide employers with real-time access to such data in a manner that will allow the employers to easily and efficiently determine employee performance, influence, and impact in the organization. The solution should dynamically provide data in manners that will allow the employers to easily understand every facet of their employees, their teams, and the organization at a whole at any number of data levels and to understand the employees' impact on the company with respect to other employees. As examples, managers should be able to determine which employee have and will, in the future, help the company achieve corporate objectives and to identify relationships among organizational members and relative employee ranking, rating, or scoring on talent attributes such as performance, potential, influence, connectedness, flight risk, amongst others. The solution may utilize statistical analysis and predictive analytics techniques upon the core employee data, recognition activity, and behavioral patterns in order to derive probability ratings for various talent attributes. Indeed, the solution should overcome the deficiencies identified above with respect to currently available recognition programs and employee reviews.

Embodiments of the invention provide members with tools for collecting and creating recognition moments in real-time (i.e., as recognition is earned). Thus, embodiments of the present invention collect and analyze recognition moments over a period of time and in an ongoing fashion, thereby allowing an employer to accurately gather, analyze and understand the employee's total impact and influence on the company over an entire period, eliminating any discrepancies or inconsistencies. Embodiments may collect the plethora of data from these recognition moments and from various other sources to provide users with insight into the employee's impact on the organization. Managers may then have access to various user interfaces that provide the real-time data and analytics results, providing managers with insight into how the employee is impacting the company at that very moment in time. For instance, in one embodiment, using the collected data, the system generates recognition network graphs that represent the recognition connections throughout the organization. The system further utilizes recognition network graphs to transmit recognition announcements throughout the organization, which in turn promotes a positive organization climate and enhances the values of the organization.

The recognition network graph and other analytical displays aid managers in determining employees who are critical to the prior and future success of their business initiatives even when those employees are not within their traditional organizational hierarchies or span of control. The recognition network graph may highlight connections between employees that are not self-evident within traditional organization charts nor found in other talent management systems. The recognition network graph may also depict how business objectives have been achieved via both formal and informal employee connections.

In one aspect of the present invention, a system for promoting employee recognition is disclosed to include a recognition data collection module and a recognition graph module. The recognition data collection module is disclosed to receive recognition details associated with a number of recognition moments and receive organizational data of the organization that may include organizational relationship data of a plurality of employees. The recognition data collection module may store in memory the recognition details and the organizational data received. Furthermore, in these embodiments, the system's recognition graph module is disclosed to generate, using at least one processor, a recognition network graph based on at least the recognition details and the organizational data containing the organizational relationship data. The generated recognition network graph contains a plurality of nodes representing the plurality of employees.

In another aspect of the present invention, a computer-implemented method for promoting employee recognition is disclosed to include the performing of a number of operations at one or more computers that include a memory and a processor. In a preferred embodiment, a computer receives organizational data of the organization that includes at least organizational relationship data of a plurality of employees and further receives recognition details associated with one or more recognition moments. These recognition details and organizational data are stored in memory at the computer. Furthermore, the computer generates a recognition network graph based on at least the recognition details and the organizational data containing the organizational relationship data. The generated recognition network graph contains a plurality of nodes representing the plurality of employees.

In yet another aspect of the present invention, a computer-implemented method for promoting employee recognition at an organization is disclosed. Like the embodiments disclosed above, a number of operations may be performed at one or more computers comprising a memory and a processor, including receiving the organizational data and the recognition details. The method further includes the steps of automatically transmitting the recognition moments received to a client device upon receiving the recognition details for display in a recognition feed to a user. A portion of the plurality of recognition feeds is discarded and an un-discarded portion of the plurality of recognition feeds is presented.

### BRIEF DESCRIPTION OF DRAWINGS

The present invention will now be described, by way of example only, with reference to the accompanying Figures, in which:

FIG. 1 depicts an employee recognition system in accordance with an embodiment of the present invention;

FIG. 2 depicts a flowchart of a method for operating the employee recognition system to provide employee recognition in accordance with an embodiment of the present invention;

FIGS. 3 to 7 illustrate a series of user interfaces that may be presented to a user to assist the user in creating a recognition moment in accordance with embodiments of the present invention;

FIG. 8 illustrates a user interface for transmitting a recognition moment in accordance with an embodiment of the present invention;

FIGS. 9 and 10 depict recognition network graphs in accordance with embodiments of the present invention;

FIG. 11 illustrate a user interface containing a recognition feed in accordance with an embodiment of the present invention;

FIGS. 12A and 12B illustrate a user interface containing user watch list and an employee recognition digest in accordance with embodiments of the present invention;

FIG. 13 depicts a user interface for delivering a recognition announcement in accordance with an embodiment of the present invention;

FIGS. 14A, 14B and 14C depict additional recognition graphs in accordance with embodiments of the present invention;

FIG. 15 depicts another employee recognition system in accordance with an embodiment of the present invention;

FIG. 16 depicts a user interface for providing users with data of employee recognition metrics using infographics and other tools in accordance with an embodiment of the present invention.

The following describes in detail various embodiments of the present invention. One of ordinary skill in the art would understand that standard programming and engineering techniques may be used to produce such embodiments including software, firmware, hardware, or any combination thereof to implement the disclosed subject matter. The attached Figures depict exemplary embodiments and are meant to be understood in view of the details disclosed herein.

### DETAILED DESCRIPTION OF THE INVENTION

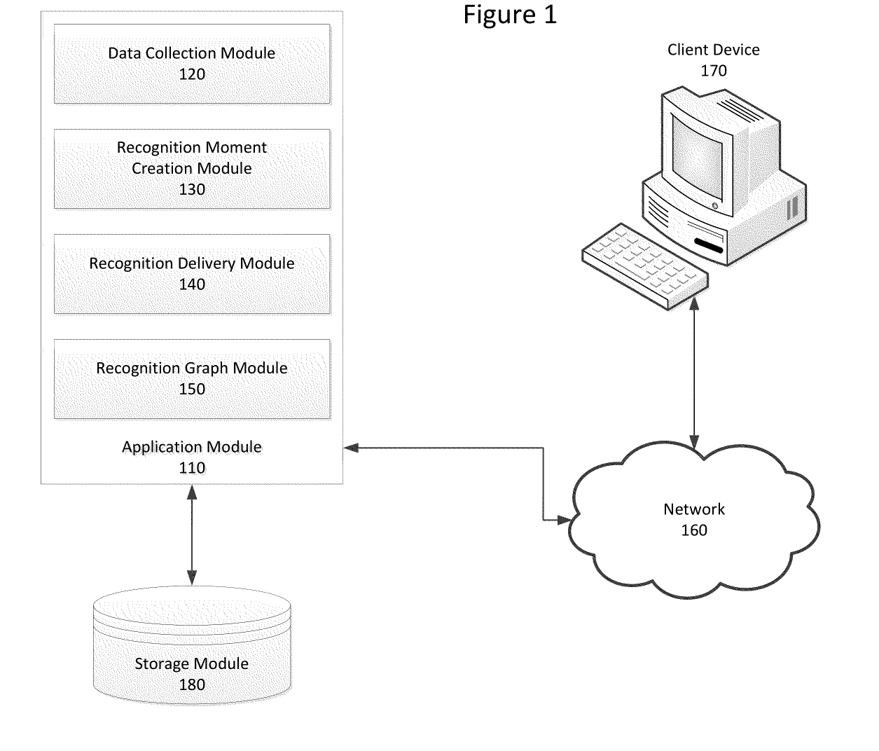

FIG. 1 illustrates an employee recognition system 100, according to an exemplary embodiment of the invention. The system 100 includes an application module 110, a network 160, and a client device 170. As illustrated, the application module 110 may include a recognition data collection module 120, a recognition moment creation module 130, a recognition delivery module 140, a recognition graph module 150, and a storage module 180, which may be a part of the application module 110 or may be a separate module. The application module 110 may be a web or application server that includes a processor and memory (e.g., the storage module 180). The application module 110 may also be embodied in software executed by a processor on a server. Alternatively, the application module 110 may execute on a machine local to a user of the system 100 (e.g., on the client device 170). For example, the application module 110 may be a software application executing within a web browser (e.g., a JAVA® Applet) at the client device 170. Storage module 180 may contain some or all of the data received, utilized, and processed by the recognition system 100 and may consist of more than one storage module located at a number of locations. In the preferred embodiment, a storage module 180 may store all of the recognition data, employee data, organizational data, and other information and data necessary to perform the operations described herein.

As used herein, references to “computer(s),” “machine(s)” and/or “device(s),” such as the client device 170, may include, without limitation, a general purpose computer that includes a processing unit, a system memory, and a system bus that couples various system components including the system memory and the processing unit. The general purpose computer may employ the processing unit to execute computer-executable program modules stored on one or more computer readable media forming the system memory. The program modules may include instructions, routines, programs, objects, components, data structures, etc., that perform particular tasks or implement particular abstract data types. The “computer(s),” “machine(s)” and/or “device(s),” may assume different configurations and still be consistent with the invention, including hand-held wireless devices such as mobile phones or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices. Thus, for example, a client device may be a personal computer, a mobile device (e.g., mobile phone, smart phone, tablet), or even a car or appliance including a processing unit and system memory.

Moreover, as used herein, references to “a module,” “modules”, “function”, and/or “algorithm” (e.g., the storage module 180, recognition data collection module 120, a recognition moment creation module 130, recognition delivery module 140, and recognition graph module 150) generally mean, but are not limited to, a software or hardware component that performs certain tasks. The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

Thus, a module may include, by way of example, components, such as software components, object-oriented software components, class libraries, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or be further separated into additional components and modules. Additionally, the components and modules may advantageously be implemented on many different platforms, including computers, computer servers, data communications infrastructure equipment such as application-enabled switches or routers, or telecommunications infrastructure equipment, such as public or private telephone switches or private branch exchanges (PBX). In any of these cases, implementation may be achieved either by writing applications that are native to the chosen platform, or by interfacing the platform to one or more external application engines.

As illustrated, the application module 110 is connected to the client device 170 by way of a network 160. As described above, while depicted as a computer in FIG. 1, client device 170 may be any device with at least a processor, including a laptop, tablet, mobile phone, and/or other mobile devices or computer systems. Thus, in one embodiment, a user may access the application module 110 with a mobile smartphone by utilizing a web browser, an application, or other access methods. Networks consistent with exemplary embodiments of the invention, including network 160, may be a wired or wireless local area network (LAN) or wide area network (WAN), a wireless personal area network (PAN), and other types of networks. When used in a LAN networking environment, computers (such as a computer executing the application module 110, or the client device 170) may be connected to the LAN through a network interface or adapter. When used in a WAN networking environment, computers typically include a modem or other communication mechanism. Modems may be internal or external, and may be connected to the system bus via a user-input interface, or other appropriate mechanism. Computers, such as the client device 170 and a server running the application module 110, may be connected over the Internet, an Intranet, an Extranet, an Ethernet, or any other network that facilitates communications. In addition, any number of transport protocols may be utilized, including, without limitation, the User Datagram Protocol (UDP), Transmission Control Protocol (TCP), Venturi Transport Protocol (VTP), Datagram Congestion Control Protocol (DCCP), Fiber Channel Protocol (FCP), Stream Control Transmission Protocol (SCTP), Reliable User Datagram Protocol (RUDP), and Resource ReSerVation Protocol (RSVP). For wireless communications, communications protocols may include Bluetooth, Zigbee, IrDa, or other suitable protocol. Furthermore, components of the systems described herein may communicate through a combination of wired or wireless paths.

In one exemplary embodiment, a user may interface with the client device 170 via a user interface. The user may enter commands and information through the user interface, such as through input devices such as a keyboard, a touch-screen, and/or a pointing device—e.g., a mouse, trackball or touch pad. In one embodiment, the user interacts with the application module 110 and its various component modules using these and other input devices in conjunction with a graphical user interface (GUI) provided on the client device 170, or hosted on a server (such as a server also hosting the application module 110), and accessed by a terminal or internet browser local to the client device 170. In one exemplary embodiment, the GUI is a web-portal on an organization's intra-net site.

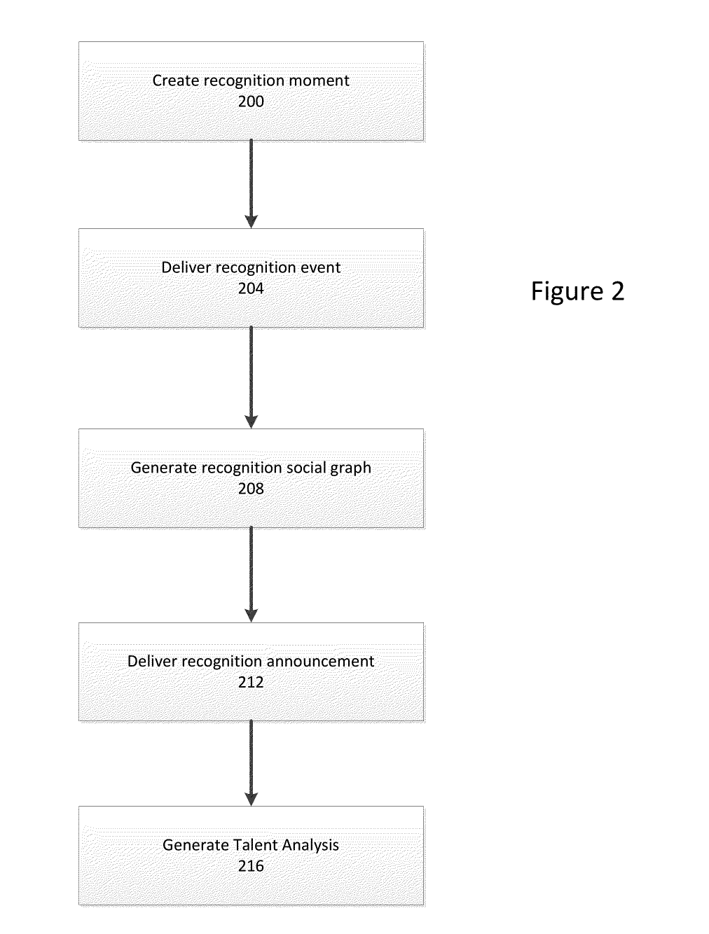

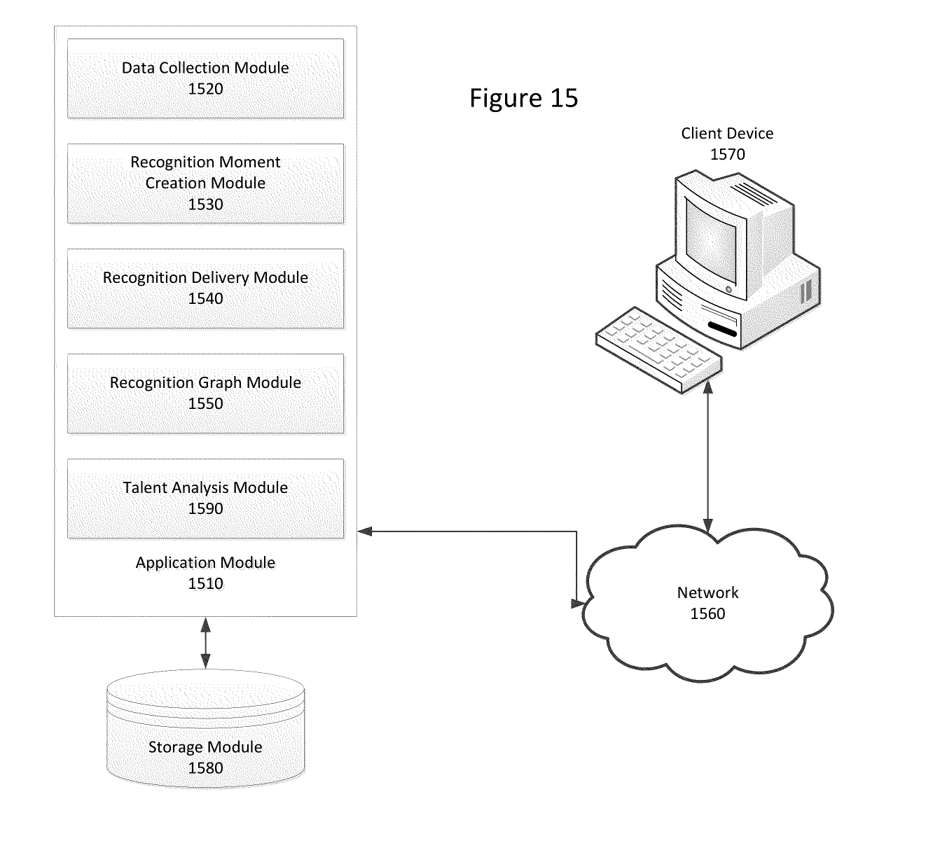

FIG. 2 illustrates the operation of the employee recognition system 100, according to an exemplary embodiment of the invention. At 200, the data collection module 120 may collect the recognition details associated with a recognition moment and the recognition creation module 130 may create the recognition moment. The data collection module 120 may also collect the organizational data of the organization. At 204, the recognition delivery module 140 may deliver the recognition moment to the recipient. At 208, the recognition graph module 150 may generate (or update) a recognition network graph for an organization based on organizational data, the recognition details of the recognition moment, and the recognition details of other previous recognition moments. At 212, based on the recognition network graph, the recognition delivery module 140 may deliver recognition announcements indicative of the recognition moment to all or a sub-set of the nodes in the recognition network graph. At 216, a talent analysis module, such as the talent analysis module 1590 of FIG. 15, may provide users with one or more user interfaces that depict the recognition data in a number of easy to understand and configurable manners. A talent analysis user interface may provide managers or others with the ability to not only define those who are members of the manager's team or group, but may also view the performance, influence, performance alignment, and other recognition data of each employee, each team and the organization as a whole. The talent analysis module may utilize at least portions of the generated recognition network graph in providing users with data related to recognition details, in view of the organizational data.

It will be appreciated by those of ordinary skill in the art that each recognition moment may be represented as a data-structure, data-type, or similar such arrangement, that is stored in volatile or non-volatile memory.

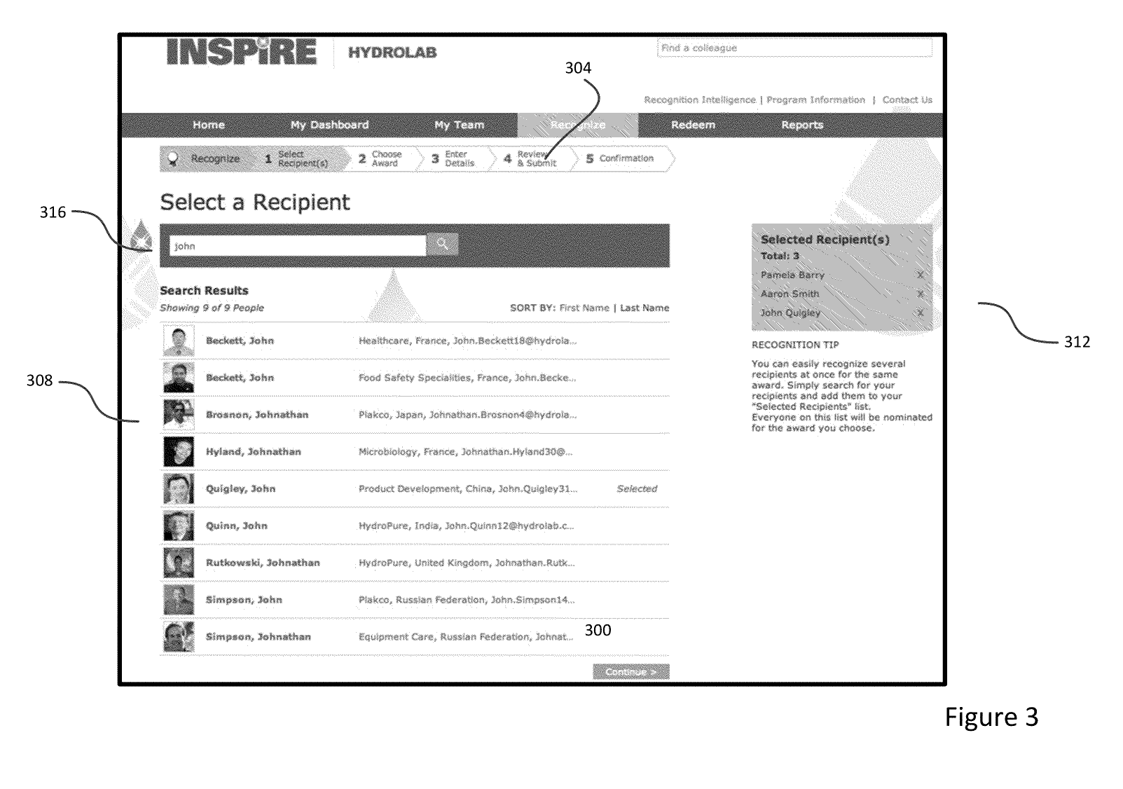

FIGS. 3 to 7 illustrate a series of user interfaces that may be presented to a user to assist the user in creating a recognition moment. The data collection module 120 may collect the recognition data inputted by the user through the user interfaces generated, with some or all of the data, in turn, being used to create various recognition moments.

A user may be assisted in creating a recognition moment and may be presented with a user interface 300 containing step indicator 304, list of eligible recipients 308, selection status 312 and search function 316, as depicted in FIG. 3. The step indicator 304 may provide the user with the steps that have been taken and are to be taken in creating a recognition moment and may be replicated (with a corresponding highlighted step) as the user progresses (i.e., it may be replicated on user interface 300-700, as shown). The user may search for recipients via the search function 316 by entering the name of the eligible recipient and may select the recipient via the list of eligible recipients 308 that are found. In one embodiment, the list of eligible recipients 308 may list all recipients eligible for a recognition moment at the organization. Eligible recipients may include all members of an organization, or some subset of that organization, including team members, department members, employees at a similar level of seniority, and any other sub-group within the organization. In one exemplary embodiment, the scope of eligible recipients may be a variable set by a system administrator. In another exemplary embodiment, the user may select groups of recipients to receive recognition. Further, embodiments may allow managers to search for employees based on attributes including number of recognitions, previous recognitions, years in the company, by location, by grade, by department, and other employee organization attributes of the employees, thereby giving every employee the opportunity to be recognized.

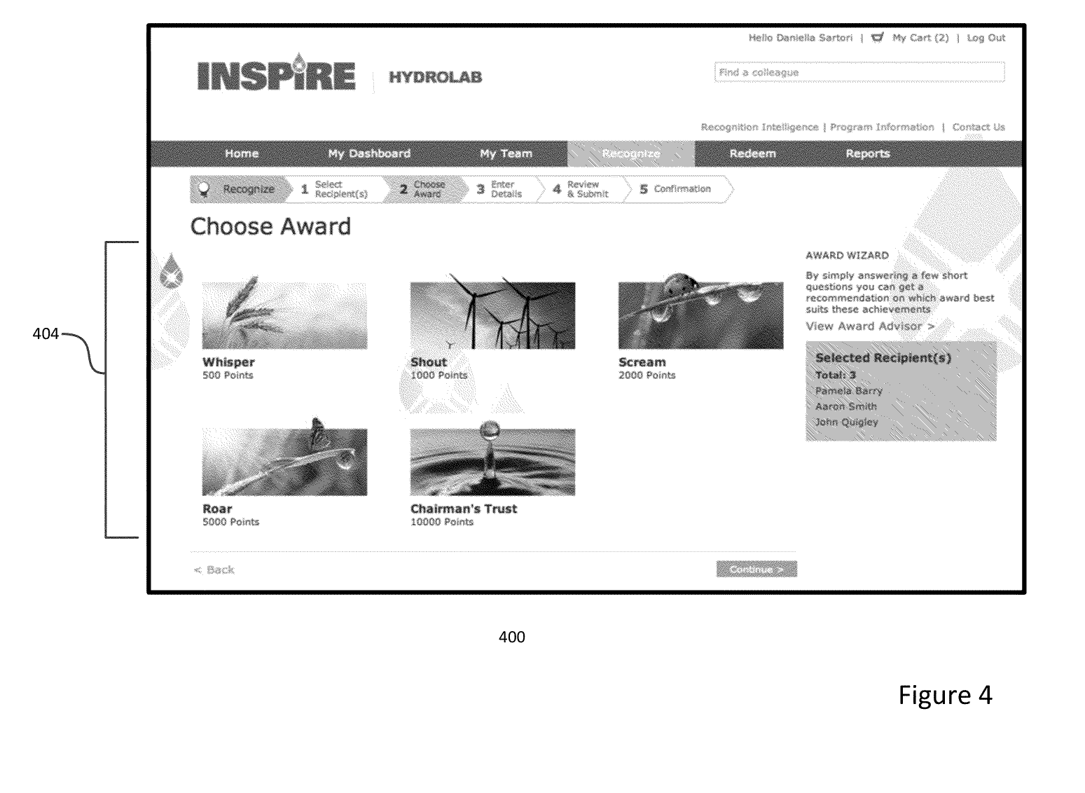

In addition to selecting recipients, the user may also select one or more awards from an award library 404 via user interface 400, as shown in FIG. 4. Awards may take many different forms, including monetary (e.g., $50), points, messages, title, relative ratings (e.g., “A+”), etc., and in each case, varying degrees or levels of recognition. Awards may also include access to redeem the economic value of an award for a reward including but not limited to merchandise, gift cards, tickets to events, access to company related, office related or team related perks. Furthermore, the awards may be a single award, or the compilation of two or more awards. For example, a user may submit both a monetary award and a rating. In addition, awards may be selected to be delivered at a particular time or at one or more periods. Thus, an employee may receive awards and associated redemption for rewards monthly over a 12-month period. In one embodiment, a user may also modify awards to be provided at a later time.

The employee recognition system 100 may suggest awards, where the suggested award may fittingly correspond with the level of achievement. The suggested award may also be based on previous awards submitted by others. For example, a specific award level with a specified economic value may be suggested because it has been given numerous times for the same or similar recognition to other recipients. In one embodiment, the user may be asked to answer a brief set of best-practices questionnaires, whereupon the award may be automatically recommended to match the level of recognition to the degree of achievement being recognized. Thus, embodiments of the present invention support company-wide consistency in the level of recognition, while preventing misuse. This further eliminates psychological barriers in adopting a recognition culture. Indeed, in at least one additional embodiment, the employee recognition system 100 includes an award monitoring module (not pictured in FIG. 1) that monitors the awards selected by all users to ensure that awards selected are appropriate. Upon the detection of award nominations that are possibly fraudulent or simply inappropriate, the award monitor module may automatically notify a supervisor or administrator for action. The monitor module may also reject the recognition nomination by the user or simply suggest to the user that the chosen award is not commensurate with the degree of achievement being recognized.

Certain awards may only be available for certain types of recognition. Awards and recognition may be categorized based on one or more levels, where the selection of a particular recognition allows for the selection of only awards from the same level or less. As one example, vacation or trip-related rewards may only be given to employees who have or are to be recognized for a top-level recognition, such as having worked for the company for 25+ years or were responsible for more than $1,000,000 in company sales.

In one embodiment, the employee recognition system 100 supports the use of virtual recognition currency. Recipients may be provided with points as the economic value of the awards, with each point representing an amount in real-world currency. In one exemplary embodiment, users may be provided with points that are each worth $0.05. Further, selectable awards may include point awards that provide to recipients predetermined numbers or levels of points. For example, in one embodiment, available awards may include: Praise (1,000 points), Cheers (2,000 points), Sing (3,000 points), Shout (5,000 points), and Amplify (10,000 points). Employees may redeem the points to purchase various merchandise and other rewards, which may be managed by a third-party company that provides a catalog of available prizes and that manages the delivery of the prizes to employees as a service.

The awards that are available for selection may further be dependent on local standards of living. Thus, certain awards may be adjusted according to high (or low) costs of living based on where the recipient resides. Awards for employees in a New York City, N.Y. office of a company may be relatively greater in economic value (e.g., number of points) than awards available to employees in the Mumbai, India office, where the cost of living is much less. Thus, for example, the Shout award given to an employee in New York City may be worth 1,000 rather than 620 points in Mumbai, India.

The employee recognition system 100 further supports the integration or connection with one or more internal and external computer systems in providing selectable awards. More specifically, the available awards may include awards that are configurable to be provided based on the data available at other systems. The employee recognition system 100 may also connect to one or more external or internal systems to provide recipients with access to certain types of awards. For example, the employee recognition system 100 may automatically connect with a ticket system to automatically place an order for a theatre tickets in response to a nominator providing the recipient with the recognition award. The employee recognition system 100 may further connect to one or more financial institutions to complete financial-related transactions including those related to tax filings.

In one embodiment, awards may be configured to be dependent on the actions of employees. Recognizable actions may vary from very specific actions and/or goal attainment to career-long milestones. As an example, not meant to be limiting to the scope of the invention in any way, a recognition nominator may configure an award based on whether a recipient has: completed a report, performed a filing, completed a project with another team member, received a number of positive praise from company clients, managed a number of employees, worked with a particular number of employees at the company, performed volunteer or public relations services, met a sales or profits requirement, billed a number of hours in a year, or worked for the company for a number of years. A recognition nominator may be any person or entity that would like to nominate an employee within an organization for recognition, such as a manager, the HR committee, a fellow employee, an employee at another organization, and others.

In addition, the actions of the employee may be in the past or in the future. Thus, in one embodiment, in response to a user defining a particular user action (e.g., via user interface 400), the application module 110 may automatically connect with one or more internal or external systems to determine whether the user has met the requirements of the award. For example, the application module 110 may connect with a task management system, database or file to determine whether a particular project task has been marked as completed within project parameters. Further, the application module 110 may connect with employee HR records to check how long an employee has been with the company. Similarly, the application module 110 may download internal or external financial results (e.g., SEC filings or internal business systems) to determine whether the company (or a division) has earned certain profits. As another example, the application module 110 may connect with the internal email system to determine whether clients have praised the recipient and/or his or her work via emails. In one embodiment, the employee recognition system 100 may send communication to a client, a supervisor of the recipient, or the recipient him or herself to determine (or simply verify) that the recipient has performed the particular task. Proof may be submitted and/or required. The application module 110 may automatically provide to the user (e.g., via user interface 400 (not shown)) the status of the recipient's actions and whether the user has performed the defined actions such that an award should be given.

In addition to verifying that particular actions have been performed, the employee recognition system 100 may further be configured to monitor for future completion of such actions. Thus, the application module 110 may automatically notify the user at a later time that the defined recipient has met the parameters defined by the user as rewardable (e.g., via email), whereupon the user may confirm that an award should be given. Suggested recognitions may be provided to the user along with other features of the present invention, such as alongside the genius recognition feed discussed in other portions of the present disclosure. Upon receiving notice, the user may connect with the application module 110 to continue (or simply confirm) the creation of the recognition moment. In one embodiment, the recognition moment may be automatically created upon detection that the recipient has met the defined parameters.

Therefore, embodiments of the present invention dynamically monitor relevant data and systems to create recognition moments instantly as they are completed, thereby allowing employees to be quickly and efficiently recognized for their hard work. Indeed, in one particular embodiment, embodiments of the application module 110 further have the capabilities to dynamically detect the need to create recognition moments based on detected actions of employees through the monitoring of one or more internal or external systems even without a user having defined the parameters to monitor. Managers may be notified as soon as the application module 110 detects that an employee has completed a project or has received praise from a client, for example. The application module 110 may also suggest awards based on previous awards, where the suggested award may fittingly correspond with the level of achievement. In one embodiment, other employees who are simply working with the recognized employee may be notified of the recognized actions and may be asked to provide additional details to more formally recognize the employee. The employees that are selected to be notified may be based on the actions that are detected to be rewardable (e.g., others on the project team associated with a rewardable task), based on hierarchy of the company (e.g., org chart), based on the relationship with the rewardable employee (e.g., via the recognition graph discussed below), or combination thereof.

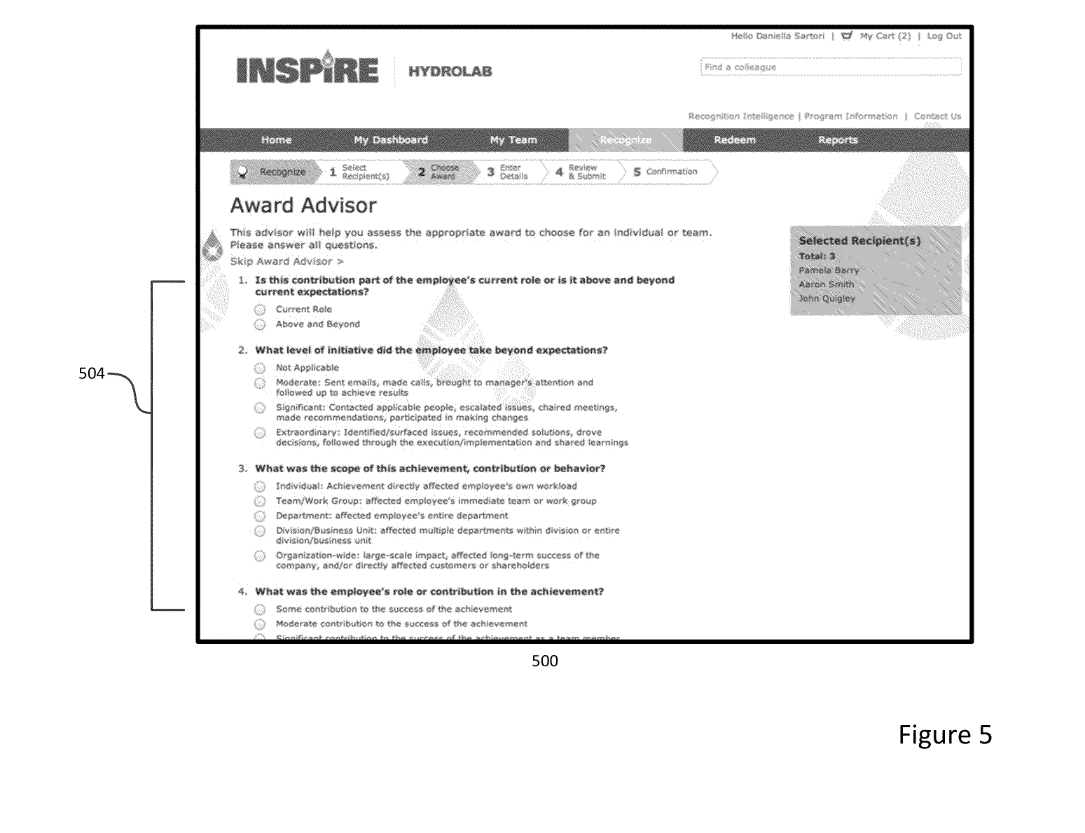

As illustrated in FIG. 5, in one exemplary embodiment, the user may also identify characteristics of the recognition moment associated with the award via user interface 500. The characteristics may include the extent to which the recipient's accomplishments are connected to their role, the level of effort (e.g., perseverance, determination) exhibited by the recipient, and the scope or impact of the recipient's effort at an individual, team, division/department, company, and/or external level. As seen in FIG. 5, the user may describe the characteristics of the recognition through a series of questionnaires 504, which may include questions that users may answer by selecting different options describing certain aspects of the recognition. An administrator, supervisor, or others may define the series of questionnaires. Other types of questions may be utilized including questions for summary/text-based answers. In one embodiment, users may further upload multimedia, such as pictures, videos, audio or others. These characteristics may be incorporated into the recognition details.

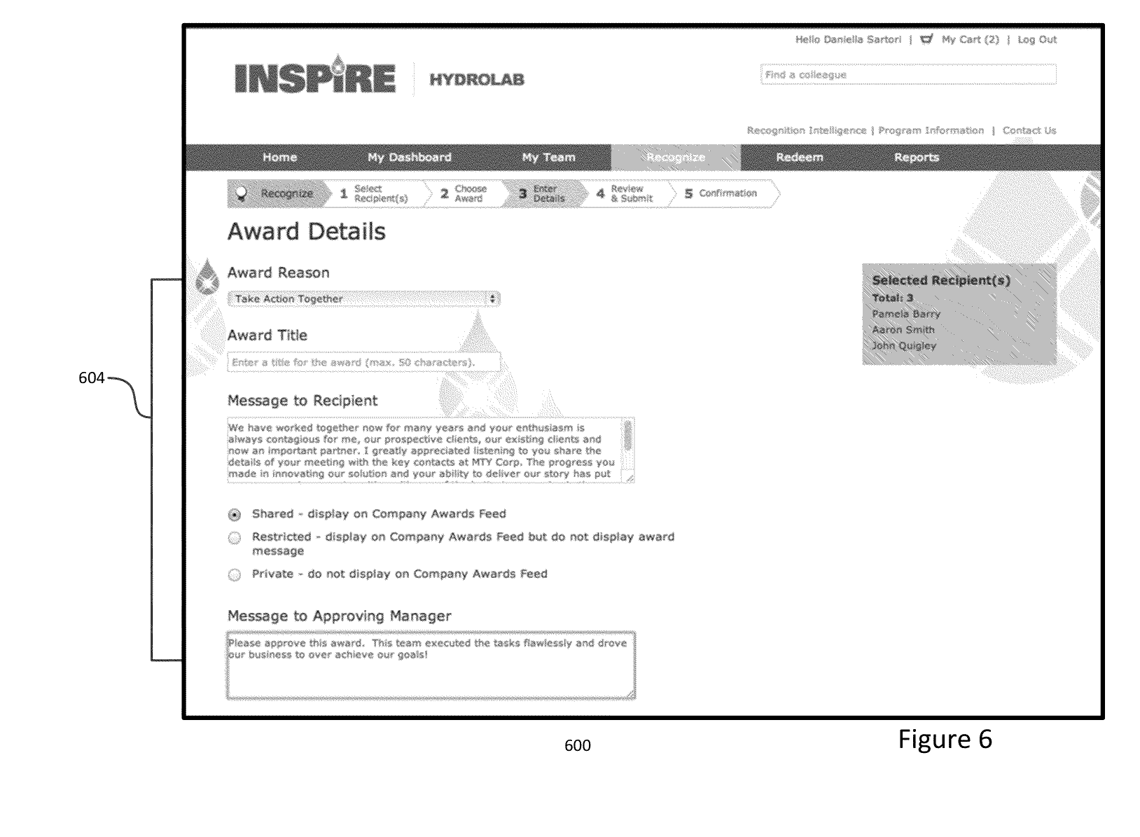

As illustrated in FIG. 6, in one exemplary embodiment, the user may identify an award reason or recognition category for the recognition moment. The recognition category may be selected from a list of pre-defined reasons or provided by the user. An administrator of the employee recognition program may submit and maintain the pre-defined recognition categories. In some exemplary embodiments, the pre-defined recognition categories for the recognition moment are, or are correlated to, specific cultural characteristics of the organization to which the user and recipient belong and which is managing the recognition program. In one exemplary embodiment, the pre-defined recognition categories include operational excellence, manager excellence, collaboration, innovation, business transformation, client satisfaction, teamwork, problem solving, and combinations thereof.

As illustrated in FIG. 6, in addition to identifying a reason, a user may also incorporate a message in the recognition moment via message input contained in input area 604. In one exemplary embodiment, the data collection module 120 can mine the message for certain key words and/or semantic analysis indicative of the recognition moment. For example, the data collection module 120 may mine the message for key words or semantic tones related to operational excellence, manager excellence, collaboration, innovation, business transformation, client satisfaction, teamwork, problem solving, and combinations thereof. Storage module 180, in one embodiment, may contain one or more databases of key words that may be searched for in a message. Application module 110 may manage these databases and, in one embodiment, may automatically update these databases from time to time (or on command) by connecting to one or more network sources (e.g., a website on the Internet) via network 160. These databases may also be updated or modified by an administrator.

In one embodiment, recognition data may be collected in bulk, such as through the processing of one or more recognition bulk files that contain data describing each recognition individually and collectively. Furthermore, in at least one embodiment, the data collection module 120 may receive recognition data from one or more internal or external systems. For example, recognitions may be communicated to the recognition system by another employee at another company. Thus, it should be apparent that while the examples described herein may describe the actions being taken with respect to a manager or user of a particular company, that in other embodiments, various other systems, internally and externally, may be configured to operate together to provide the same or similar functions described herein.

In addition to the above-listed recognition data, additional recognition data may be collected in various embodiments of the present invention, including: data related to the reasons for the recognition; data related to the significance of each award (e.g., recognition level, category, ranking or importance); sphere of influence data; connection strength between nominator and nominee; validation data (e.g., number and structure of congratulations received from employees for recognition); composition of the recognition message (e.g., keywords, length); approval data (e.g., award was approved by HR committee); and recognition distribution data (e.g., value of award versus average or normalized distribution of awards; variance from nominator's average nomination or rate of nomination, and conformity to average award economic value, frequency, and reaction). Various other recognition details data may be collected in other embodiments of the present invention.

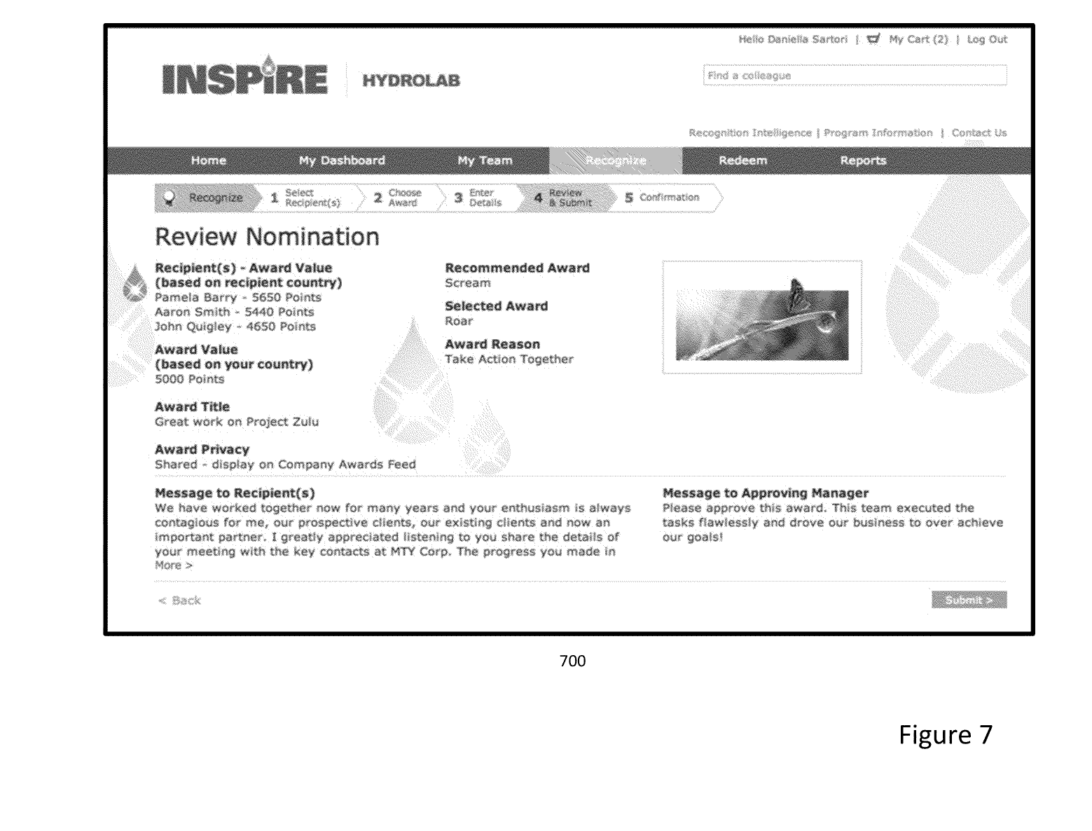

After the recognition data collection module 120 finishes collecting the above noted recognition data, the recognition moment creation module 130 may generate the recognition moment. As illustrated in FIG. 7, the user may optionally review the details of the recognition moment, the user interface 700 displaying to the user the user's selected recipients, award, award value, award reason, award title, message to recipient, message to approving manager, and other information. In one embodiment, the user may further be provided with a view of the updated recognition map if the user were to enter his or entry. The displayed recognition map may highlight the effect the user's recognition submission would have on the recognition map. The user may be asked to submit the nomination and finalize his or her entry.

In a preferred embodiment of the present invention, recognition moments that are collected by the recognition data collection module 120 must be approved before the recipient is provided the award and is recognized. Thus, in at least one embodiment, a supervisor or administrator may receive a notification that the recognition data collection module 120 has collected a recognition nomination. The employee recognition system 100 may further generate one or more user interfaces from which an administrator or supervisor may access a list of all pending recognition nominations, allowing for the easy review and approval of the nominations quickly and efficiently. The approver may further review where the nomination is in the approval workflow (where nominations require one or more approvals). The notification may contain some or all of the details of the recognition data that the user reviewed and entered using user interfaces 300, 400, 500, 600, and 700. The administrator or manager may confirm the recognition, edit the details of the recognition (including the reward), and communicate with the award nominator regarding the reward. The approver can also add their own words of congratulations during the nomination process, thereby fortifying the meaning of the award in the eyes of the recipient. In one embodiment, any changes made by an administrator or manager may be transmitted to the nominator for approval or simply as a form of notification that changes have been made.

In one embodiment of the present invention, the number and level of approvals required might be dependent on the award that is to be provided to the user. The larger or more valuable the award, the more levels of approval may be required. For example, where 1,000 points are to be awarded, only 1 level of supervisory approval may be required, whereas the award of 10,000 points may require 2 or more levels of supervisory approval.

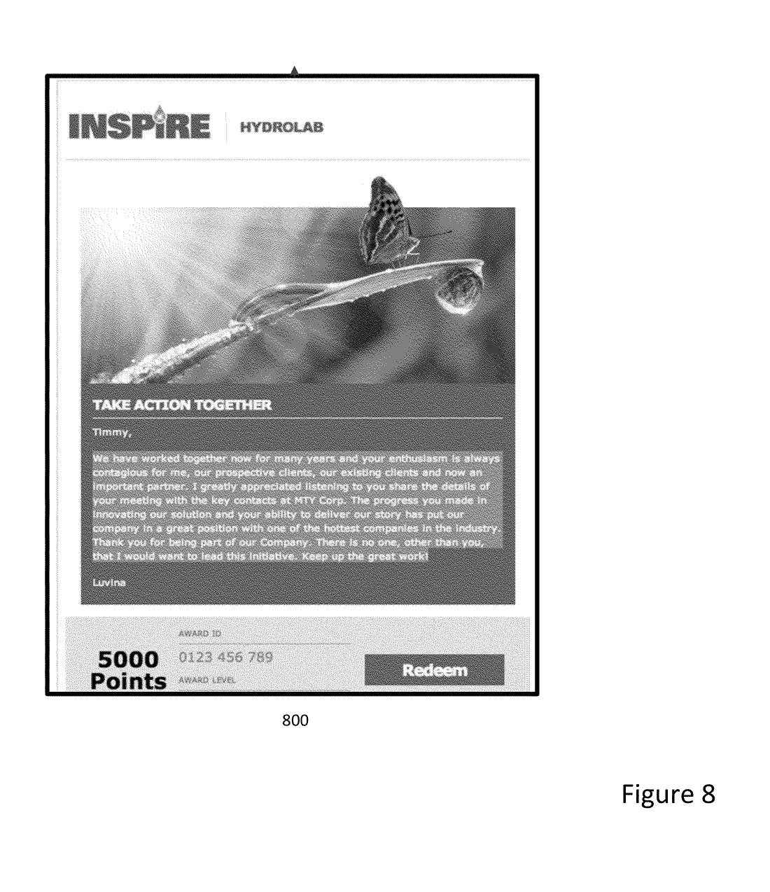

As illustrated in FIG. 8, after optionally reviewing and approving the recognition moment, the recognition delivery module 140 may transmit the recognition moment to the recipient. In one exemplary embodiment, the user may transmit the recognition moment via e-mail. In other exemplary embodiments, the notice may be transmitted to the recipient via a portal site, the recognition feed (below), over twitter feed, push notification, rss feed, text message, other similar transmission methods, and combinations thereof. In certain embodiments, recognition moments may be provided to a proxy of the recipient, such as the recipient's manager or a proxy that the recipient has designated, such as the recipient's family member, coworker or others. The message that is provided publicly may be restricted according to the desires of the user or recipient or according to administrative settings, as such messages may contain confidential corporate information. In some cases, only the award title and reason may appear publically. In yet another embodiment, the recognition delivery module 140 may cause a card or letter to be printed and delivered to the recipient.

Transmitting the recognition moment may also include funding an account associated with the recipient (e.g., with points or money). Thus, the recognition delivery module 140 may connect with one or more financial service systems via network 160 to cause the transfer or wiring of funds, the purchase of products, gift cards, merchandise and/or tickets, order rewards related services, and the performance of other actions related to the selected awards. The recognition delivery module 140 may receive, in response, a confirmation of the ordering of the award and may further provide the recipient and/or an administrator with the information as needed.

In addition to the recognition data, organizational data may be collected by the data collection module 120, which may include data describing the organization, its teams, and its employees. The organizational data, in one preferred embodiment, will include data describing the organization's structure, including the employment classification of each employee, the members and size of each team or division, the engagement level between divisions or teams; as well as the relationship between teams and between managers and employees, such as which employee reports to which manager and which employees work together, for example. Indeed, the organizational relationship data need not be limited to information that may be contained in an organization's org chart, but may include various other organizational information that may be relevant in determining the connections between employees of the organization, such as the office or cubicle location, interests, projects or clients, length of employment, educational, social background, functional groups (e.g., unofficial teams), employment history (e.g., previous connections); performance rating, grade; social network connections; the recognition participation by employees and/or managers; and the reach and frequency of recognitions within (and outside of) teams and divisions. Various other organizational data may be collected in other embodiments of the present invention.

### Recognition Network Graph

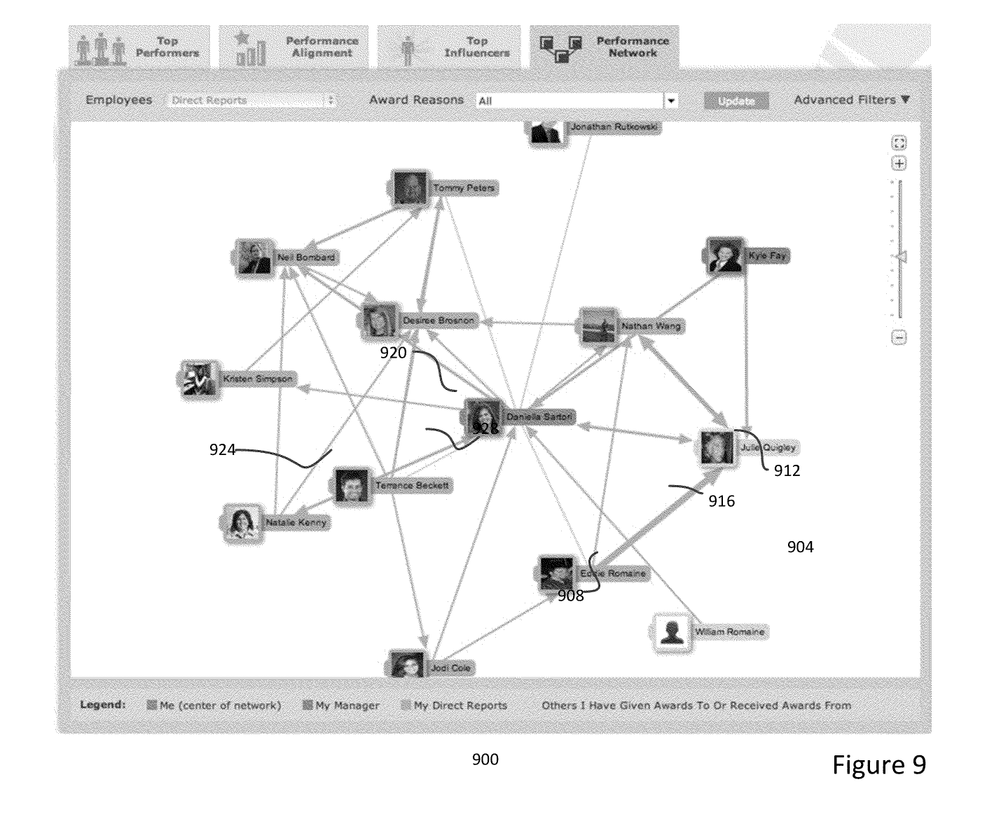

The recognition data associated with each recognition moment and the organizational data may be collected, stored (for example, in the storage module 180), and further be utilized to generate one or more recognition network graphs, such as the recognition network graph 904 displayed as part of user interface 900 shown in FIG. 9. The recognition network graph 904 is a directed graph that illustrates the recognition connections within an organization, comprising of nodes and links. The recognition network graph 904 visually graphs the relationships between individuals and their colleagues. The nodes of the recognition network graph 904 may represent individuals, teams, divisions, departments, and any other entity capable of some level of interaction with another entity. The links, which may be depicted as graphical lines, edges, arcs, other graphical objects, represent the connections between the nodes, which may be recognition connections, organizational connections, and combinations thereof. The directional component of the links may represent the node that originated a recognition moment, and the node that received the recognition moment. In one embodiment, the directional component may also represent the reporting connection from one employee to his or her supervising employee, or vice versa.

The recognition graph module 150 generates the recognition network graph 904 based on the recognition data comprising the recognition moments in combination with organizational data. The various nodes that comprise the recognition network graph 904 are determined from the organization data and from the recognition moments. The links are then added based on the recognition data associated with the recognition moments and optionally according to organization data (org data). In one exemplary embodiment the links that are based only on organization data may be a different color or different form (e.g., solid versus dashed) than the links associated with recognition moments. Because the recognition moments may be created in real-time, the recognition network graphs may also be created in real-time. Organization data stored by the employee recognition system 100 (e.g., at the storage module 180) includes relationships between employees (e.g., an employee's manager), employee relationships to various organizational hierarchies (e.g., hierarchy of departments or hierarchy of geographical locations), and other organizational data collected by the data collection module 120, such as those described at [0062].

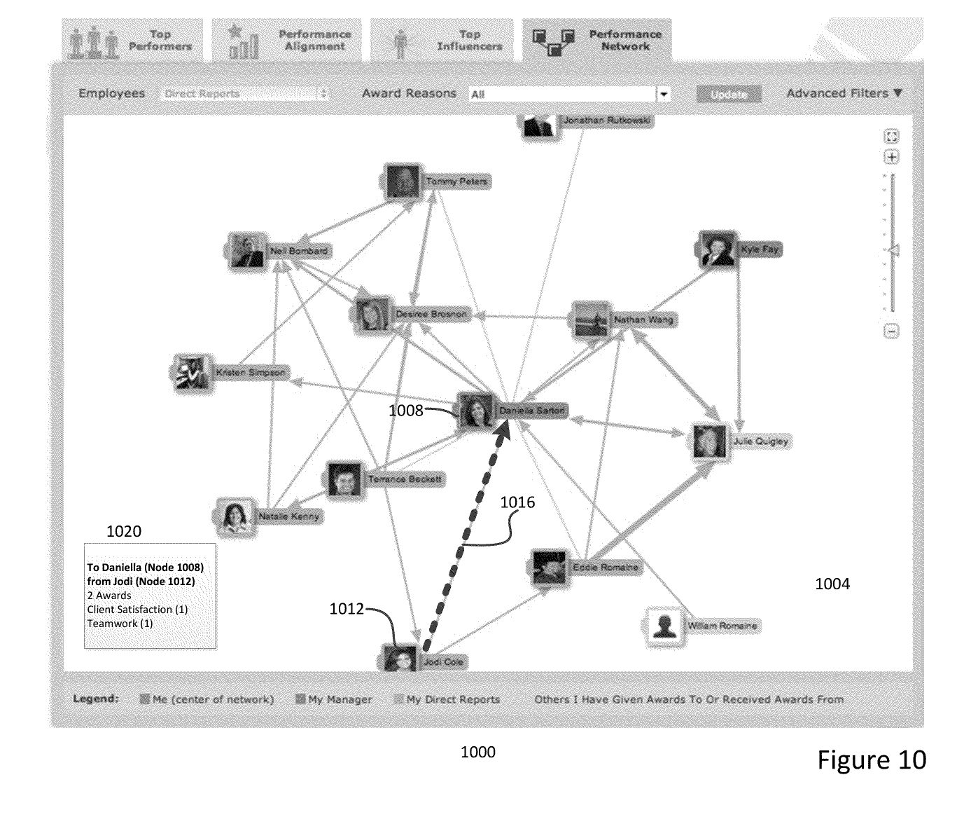

Nodes on the recognition network graph may be determined based on the union of an employee's organizational attributes (e.g., his/her manager, employees for whom he/she is their manager, and/or other shared employee attributes such as organization department or geographic location), as well as those other employees with whom an employee has had a recognition moment of giving a recognition moment to or receiving a recognition moment from. The recognition graph module 150 may also generate the recognition network graph 904 in FIG. 9 by leveraging interactive software and web-based software such as Flash and/or HTML. As illustrated in FIG. 10, connection details may be associated with each link between two nodes. The connection details may include the identity of the person who created the recognition moment, and the identity of the recipient of the award; the number of awards from the first node to the second node; the categories of reasons for the recognition moments; the number of recognition moments associated with each category, and other information.

The thickness of the links may increase or decrease based on a number of factors, alone or in combination, including: the number of recognition moments between two nodes, the number of different categories of recognition moments, and the quality of the recognition moments. Thus, node 908 and node 912 may be associated with one another with 5 recognition moments. The relationship may, therefore, be represented by thick link 916. In contrast, node 920 and node 924 may only have one recognition moment associated between themselves, and so be represented by the thin link 928. In addition, quality of a recognition moment may be based on a number of factors, including the relative importance of the category of a recognition moment to an organization. In at least one embodiment, along with the thickness of the links, the shape, pattern, color, or other display characteristics of each link may also be dependent on the recognition data.

These factors are understood to relate to the “strength” of the recognition connection between two nodes (i.e., members of an organization). In other exemplary embodiments, the thickness may be based on the correlation between the creator's recognition moments and formal employee performance scores of the recipient of the recognition moment (i.e., that employee's awards are a strong predictor of the employee's performance). By depicting the number of recognitions between each employee of a team or organization, managers and administrators may recognize important and influential employees of the organization, such as those who contribute the most to the company and those who are well regarded by his or her colleagues.

Link thickness may also be based on attributes relating to the award employees have received and given, such as the number of awards received or given; the reason for the award; significance of the award; reward status; organizational relationship; sphere of influence and connection strength of the person who gave the award; additional validation of the award in the form of congratulations from other employees; length and content of the award message; conformity to average award economic value, frequency, and reaction; variance to giver's norms; approval or disapproval of awards submitted; and value distribution of awards, and others.

Link thickness may also depend on the employee's team, manager and division, including the size of team and division; engagement level of the division or team; recognition participation of the manager; and reach and frequency of recognition within the team and division. In another embodiment, the thickness of the link may depend on objective data about the employee, such as the employee's division, level, gender, age, diversity, performance rating, employee history, grade and grade history, and functional group. Furthermore, link thickness may take into consideration the recognition activities of each employee, including the employee's participation in recognition programs; the number of connections through recognition, including strength, organizational relationship; ratio of recognition given to recognition received; recognition compared to peers; recognition given by manager and how that compares to organizationally close managers.

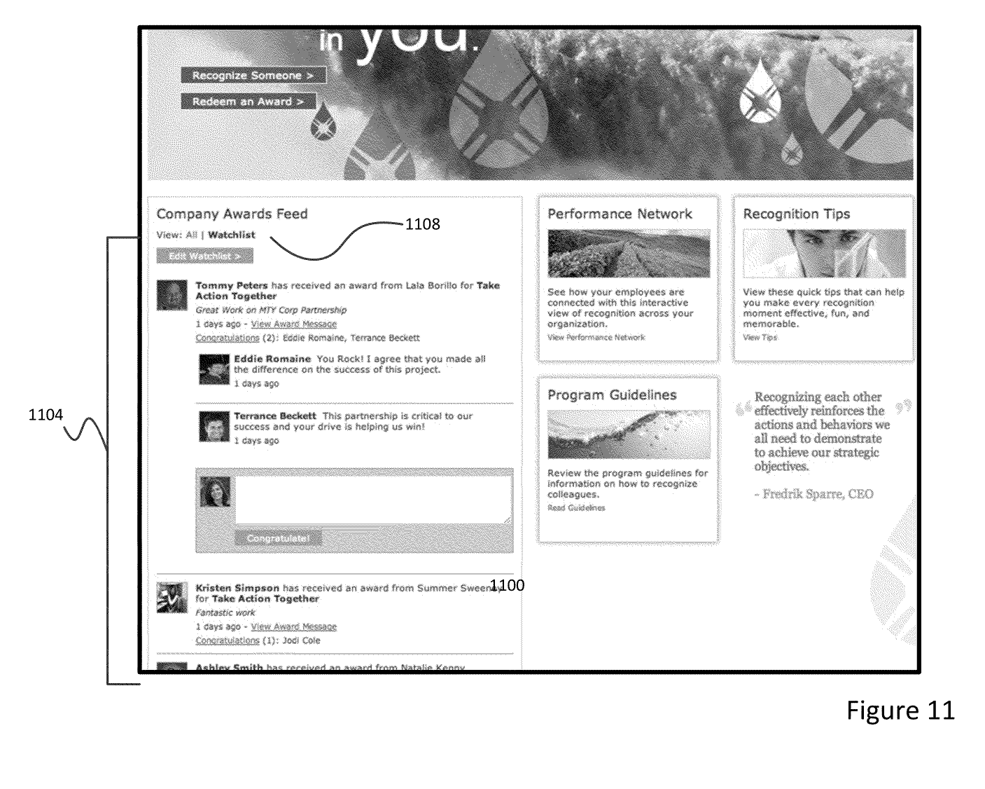

In one embodiment, the thickness of the links may be further increased by feedback received as a result of recognitions. In one embodiment of the present invention, after a recognition moment has been delivered and/or announced, other employees of the organization may show their appreciation for the employee's achievement or action by congratulating the employee. An employee may provide feedback with respect to the recognition moment through a number of available methods. For instance, an employee may press a “congratulations” button next to the recognition moment on one or more user interfaces, such as those described herein. In addition, in one embodiment, an employee may also (or in the alternative) provide a comment in response to the recognition moment. For instance, FIG. 11 depicts a user interface wherein, in response to a recognition on an employee's award feed, the employee may send a message to the recognition recipient with a congratulatory message. Thus, in a particular embodiment, the more congratulatory messages received, the thickness of the links between the recipient and the person congratulating (e.g., Terrance of FIG. 11) may be increased (or created). In one embodiment, the thickness of the link between the award nominator and the recipient (e.g., Tommy and Lala of FIG. 11) may also be thickened as a result of these congratulatory messages.

In one exemplary embodiment the recognition graph module 150 may utilize “scores” associated with the recognition moments to determine the thickness of the links. Each award associated with a recognition moment may be converted to a score. For monetary and point award forms, the conversion of the award to a score may be a ratio conversion such as a 1-to-1 conversion, 1-to-2 conversion, 2-to-1 conversion, or variations thereof. For other recognition forms, a conversion table assigning score values to the award may be adjusted based on the varying degrees or levels of recognition. For example, a message thanking an employee for working hard may be worth 50 points, and then adjusted by a multiplier based on extent of the user's gratitude. In addition, the characteristics associated with the recognition moment described herein may also be used to further adjust the score associated with the recognition moment and may each have an associated value or weighing factor that may be used to adjust a score associated with the recognition moment. As one example, not meant to be limiting, one or more recognition data categories described in paragraphs [0065] through [0070] and paragraphs [0072] through [0074] may be utilized to calculate a score associated with a recognition moment with each having differing score weighting factors that may affect the recognition scores.

Further, the scores associated with recognition moments may depreciate over time to reflect the risk of a weakening recognition connection between two individuals over time. In one embodiment, the scores may further be dependent upon the organizational relationship of the nominator to the recipient. Scores may also be dependent on the absolute level or status of the nominator. For instance, a score may be higher when the president of the company recognizes an employee or when a direct manager recognizes his or her direct subordinate. Various other methods of scoring based on the relationships of the nominator and recipients may be utilized as a means to promote corporate values and goals. Furthermore, scores may be dependent on the sphere of influence of the nominator and the conformity of the award to the norms. Thus, in one instance, a score may be higher because one particular recognition is for an achievement rarely achieved or for a recognition rarely recognized.

In another embodiment, the size, color or other display characteristics of the nodes representing each employee may be dependent on some or all of the factors described above with regard to link thickness as well as other factors or attributes described herein, such as the number of recognition moments the employee has received, the scores, recognition activities, the absolute level or status of the nominator, the sphere of influence of a nominator, and the conformity of the awards to the norms, and others. Through these features, managers may quickly and easily recognize influential or important employees of the organization.

While the input data described above may be utilized to generate one or more recognition network graphs, including determining node links and nodes, such data, including any combination thereof, may also be utilized by any of the modules or engines described herein in operation and in order provide users (e.g., managers) with access to a wide range of data describing the employee's impact, performance and potential. For instance, such data may be utilized in one or more statistical analysis algorithms and predictive analytics techniques, such as neural network models and multiple linear regression, in order to assess talent and predict results and effects.

In one exemplary embodiment the recognition, recognition network graphs may be filtered to only show nodes connected to a user because of recognition moments associated with a particular recognition detail. For example, the recognition network graph may only show nodes connected to another node where there exists at least one recognition moment associated with Innovation as the award reasons (or in the body of the award message).

In one exemplary embodiment, each detail itself may be connected to other details as part of a tree structure. For example, as shown in FIG. 10, selecting a “Teamwork(2)” recognition category of the connection details 410 (not shown) may display the details of two “Teamwork” related recognition moments between “Daniella” and “Jodi.” The link 1016 between node 1012 (representing Jodi) and node 1008 (representing Daniella) may be highlighted for the user and connection detail 1020 may be displayed on user interface 1000 and/or as part of recognition map 1004.

In one embodiment, users interacting with the recognition network graph 1004 may select other nodes and re-center the depicted graph. For example, the recognition network graph 1004 in FIG. 10 is centered on Daniella (i.e., node 1008), but a user/viewer may re-center the graph on Jodi (i.e., node 1012), in which case, node 1012 would appear at the center of the graph instead of Daniella (node 1008). By centering the graph on node 1012, the system recalculates and displays the appropriate nodes and the links based on node 1012's organizational data and recognition moments.

In one embodiment of a recognition network graph, the nodes within the graphs are positioned in a manner similar to that of a traditional organization chart (“org chart”). Thus, nodes may be positioned in accordance with the organizational hierarchy within the organization wherein nodes representing higher level officers may be positioned near the top of the chart and may be connected to nodes representing the officers' direct reporting managers. The nodes of the managers may be positioned below the nodes of the officers. Further, nodes representing lower-level employees may be connected and be positioned below the managers' nodes. Thus, in certain embodiments of these org-oriented recognition network graphs, a recognition network graph may be depicted as to illustrate the organizational hierarchy of the organization in a top-down manner. In one preferred embodiment, at an initial step, the recognition graph module may generate the org-oriented recognition network graph to contain a graphical link for each organizational reporting connection (e.g., a link for each supervisory responsibility/report). By default, the graphical links may not contain any arrows or may be in a default color, pattern or shape to represent the organizational connections. Then, the recognition graph module may alter or regenerate the recognition network graph to contain the recognition moments between the employees of the organization. The graphical links representing these recognition moments may be of different colors, shape, or pattern, or may have arrows indicating the directions of the recognition nominations. As described with respect to other embodiments of recognition graphs, various filters, selectable view options, and navigation tools may allow a user to customize the scope of data being visualized within the graph. It should be appreciated that various other methods of depicting org relationships may be generated by the recognition graph module.

Thus, a user viewing the recognition network graph may not only determine the organizational relationship between the plurality of employees, but may also receive a visualization of the recognitions within the organization. Furthermore, embodiments of such network graphs allow for the immediate understanding of recognition moments with respect to the organizational structure. A user may quickly understand the sources of recognitions and those being nominated, such as whether enough recognitions are being provided from supervising employees to their reporting employees, whether certain managers have a good relationship with their direct report, whether employees of the same level are team players by recognizing others at their same levels, whether officers are recognizing their managers and so on. Therefore, a user may quickly gather whether various levels of employees are effectively utilizing the recognition system and to take corrective actions accordingly.

A user may rotate, pan, zoom, and otherwise navigate the recognition network graph 1004 and select each nodes and links for more information. In one embodiment, the recognition network graph may contain a range of viewing levels, with the top level depicting a high-level view of the recognition map and with the lowest level depicting a low-level view of the recognition map, and with each level representing another level in the corporate hierarchy. For example, at the highest level, a single node may represent one single company. Links between such nodes may illustrate the recognition strength between companies. At the second level, nodes may represent branches of companies, with the level below that including nodes that represent teams within the company branches. As with the highest level, the links at the second and third level may represent recognitions between branches and recognition between teams, accordingly. Finally, the lowest level may include nodes that represent employees, as described above. In one embodiment, the recognition network graph may also show links of employees from numerous teams, and even those from other branches and companies as well.

The graph 1004 may also be filtered based on any number of definable attributes, such as based on time range, award level, award reasons, teams, divisions, types of awards, nominators and recipients, and others. Thus, as seen in FIG. 10, a user may only choose to view the recognitions of Danielle and other employees where the award was for “Good Teamwork” or for “Met a Substantial Deadline.”

In one exemplary embodiment, a user may identify another member of the organization for whom they want to identify a pathway based on recognition and org data. The recognition pathway is the path from the user to the identified individual over several nodes according to the recognition data and the organization data. Thus, the path represents the degrees of separation from one employee to another specified employee (or member of the organization) through other connected employees based on both organizational relationships and/or connections via recognition moments.

While the recognition network graph described here is disclosed to be made up of a plurality of nodes connected by links on a two dimensional graph, embodiments of the present invention further includes recognition network graphs that are made up of different types of nodes, connectors, and/or other elements that are graphed on a graph two, three or more dimensions. Furthermore, nodes need not be connected by any graphical connectors at all. Additionally, the recognition network graph may be integrated with other graphs disclosed or mentioned herein.

### Recognition Feed

In addition to the e-mail delivery illustrated in FIG. 8, the recognition delivery module 140 may also deliver a recognition notice over a recognition feed, such as the recognition feed 1104 illustrated in FIG. 11. In one exemplary embodiment, the recognition feed is a recognition moment feed managed as part of a web or intranet site associated with employee recognition. In another embodiment, the recognition moment feed may be managed by one or more computer systems and/or server systems including server systems, computers, mobile phones, tablets, other mobile devices, and other types of systems well known in the art. By providing the recognition feed within an intranet, sensitive corporate information may be protected and detailed recognition information may be provided to the employees of the company. In certain instances, privacy options may also be enabled to hide parts or all details of a recognition instance. Thus, embodiments of the present invention may further create a culture of appreciation by delivering a continuous stream of the latest recognition activity at a company, allowing employees to see real, concrete examples of behavior that embody company corporate values, for example.

The recognition feed 1104 may be syndicated via technologies as RSS and Activity Streams to be displayed on web or corporate intranet portals, corporate social media technologies associated with employee information beyond recognition (e.g., an employee internal portal), and/or general social media pages (such as social media pages managed by Facebook®), Twitter®, mobile readers, and combinations thereof). Recognition feed 1104 may include the name of the recipient of a recognition moment, comments and congratulations, and a comment box for submitting comments and congratulations. Congratulations from an employee on another employee's recognition awards create an additional recognition moment between those two employees which is leveraged to create the nodes on the recognition network graph. Optionally, the recognition feed 1104 may provide various recognition details including the name of the creator of the recognition moment, the reason/recognition category, a reference to a client or account, and combinations thereof. Those of ordinary skill in the art will recognize that other details could be added than those expressly identified above. In at least one embodiment, the recognition feed may further integrate data and features from available talent management software and systems.

The recognition feed 1104 may receive notices of recognition moments from all members of an organization or a subset of the members of the organization identified in a watch list 1108. In one exemplary embodiment, the recognition feed 1104 is implemented as a publish/subscribe messaging system. In one exemplary embodiment, a user may filter their recognition feed 1104 by adding and removing people to and from the watch list.

In another exemplary embodiment, feeds may be automatically generated according to the watch list 1108 by an algorithm, such as the genius algorithm 1204. The genius algorithm 1204 may add people to the watch list 1108 based on direct and/or indirect reporting relationships or shared management levels and other shared organizational data between employees, recognition moments (and the recognition data that comprises those moments), congratulations, and combinations thereof. The genius algorithm 1204 may update the members listed in each user watch list daily, weekly, monthly, or on command, and may be updated based on the new award activity and organizational relationships. For example, one genius watch list may include a manager's direct reports on his or her watch list 1108. The watch list 1108 may further contain coworkers who share the same manager as well as anyone to whom the manager has ever given awards. Thus, the genius algorithm 1204 may automatically manage the watch list 1108 in accordance with any number of organizational data. In one embodiment, the genius algorithm 1204 may automatically manage the watch list 1108 to include each of the employee's organizational relationships and/or based on the structure of the organization.

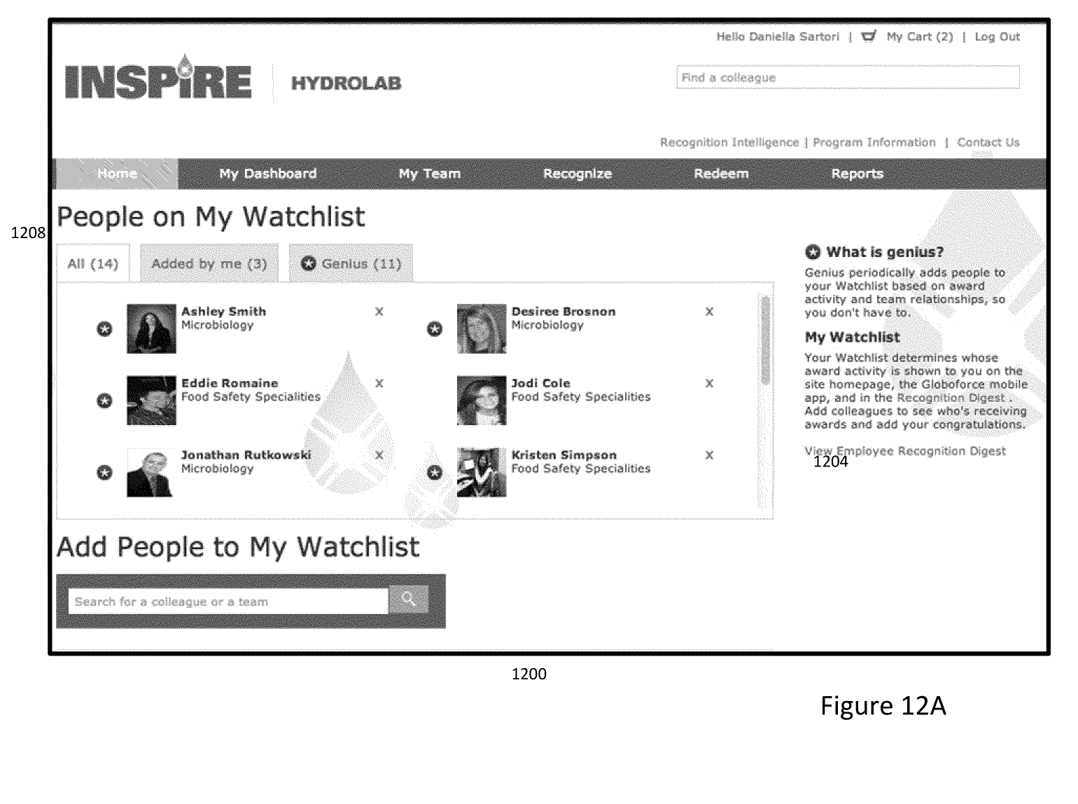

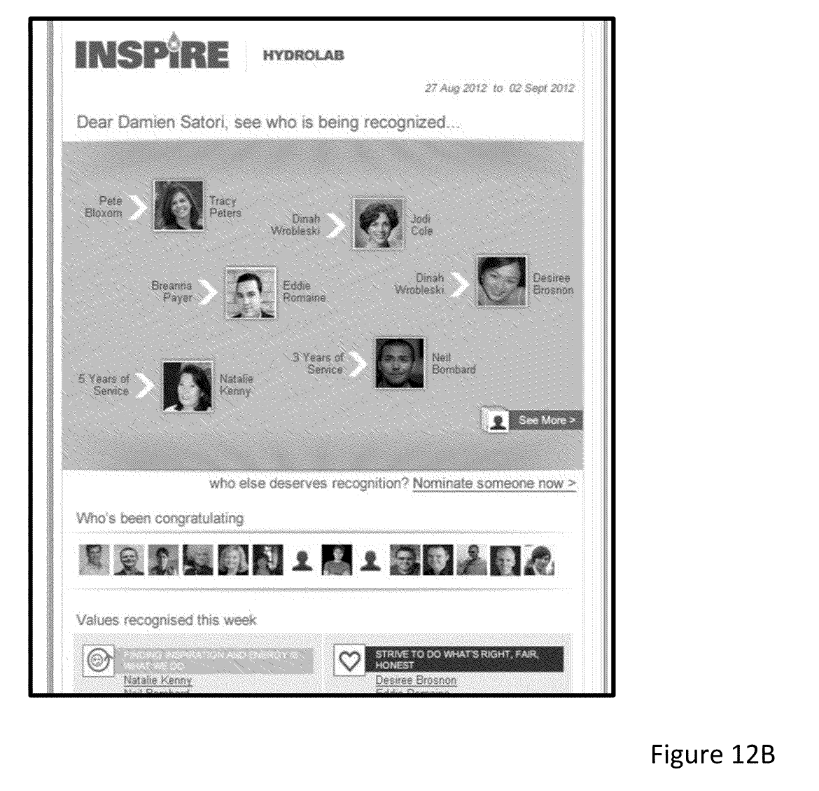

When utilizing recognition moments to add people to the watch list 1108, the genius algorithm 1204 may rely on recognition graphs, such as the recognition graph 1004. In particular, the genius algorithm 1204 may add those people for whom a user has created recognition moments for, and those people who created recognition moments for the user. In one exemplary embodiment, the genius algorithm 1204 may consider the strength of the connection between two users (e.g., as illustrated by the thickness of the link connecting two nodes in the social network of FIG. 12A) when determining whether to add someone to a watch list. Thus, in FIG. 12A, the application of the genius algorithm 1204 results in the addition of Ashley Smith, Eddie Romaine and others to the watch list 1208. In one embodiment, the genius algorithm 1204 suggests to the user people that should be on the user's watch list.

The genius algorithm 1204 may also utilize data available at internal and external computer systems related to the user. In one embodiment, the employee recognition system may connect to email or other messaging systems to determine with whom the user communicates the most and the least, in order to form the recognition watch list 1208 accordingly. Similarly, the genius algorithm 1204 may access one or more org charts or floor plans to filter the user's watch list 1208 to others on the user's team or who sits near the user. The genius algorithm 1204 may cause the access and downloading of information from internal or external social networks to detect coworkers who are also friends or associated with the user's social network accounts. Further, the genius algorithm 1204 may detect similar interests or attributes between coworkers and the user via one or more social networks. Those of ordinary skill in the art will recognize that the genius algorithm 1204 may utilize additional factors in determining whether to add someone to the genius watch list. Data from any number of internal or external systems may be collected and utilized by the genius algorithm and other features of the present invention to provide managers and users with insight into recognition data.

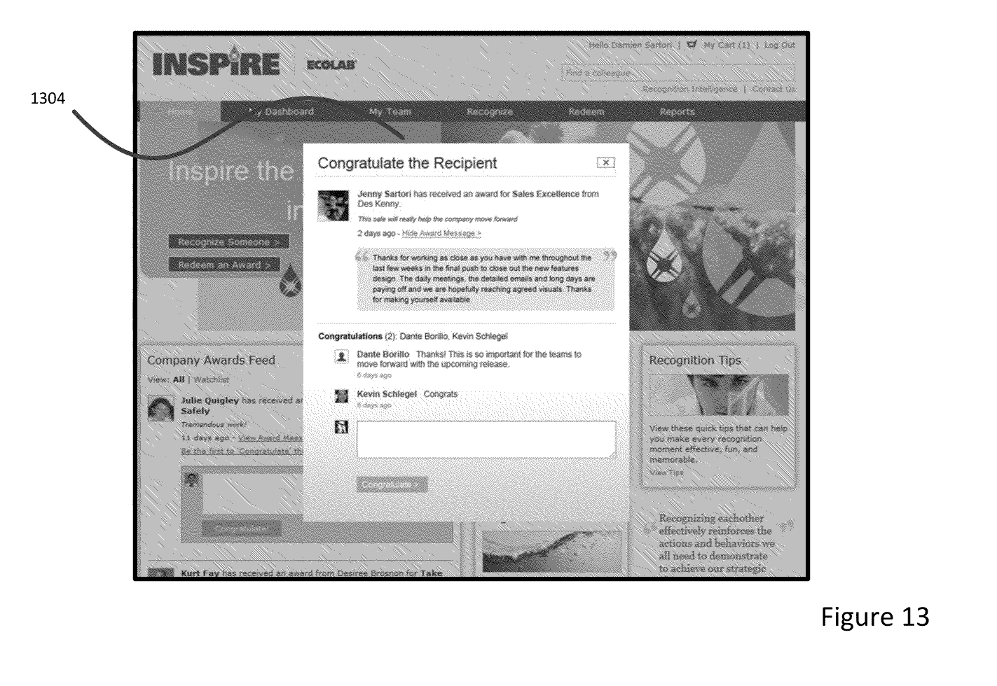

In one exemplary embodiment, adding and removing feeds are accomplished by filtering out unselected or unwanted feeds. In addition to (or in lieu of) sending the recognition feed 1104 via RSS, the recognition delivery module 140 may send the recognition feed (or a snapshot thereof) via an e-mail as depicted in 12B. Users may directly congratulate colleagues from such emails. Similarly, as illustrated in FIG. 13, the recognition delivery module 140 may deliver the recognition announcement via a dialog box 1304, prompting a user to send congratulations.

### Influence, Performance Alignment, Performance and Other Recognition Graphs

The recognition graph module 150 may utilize the recognition data collected and/or recognition network graphs to generate various other recognition graphs, including graphs that describe top performers, top influences, performance alignment, and other relevant information.

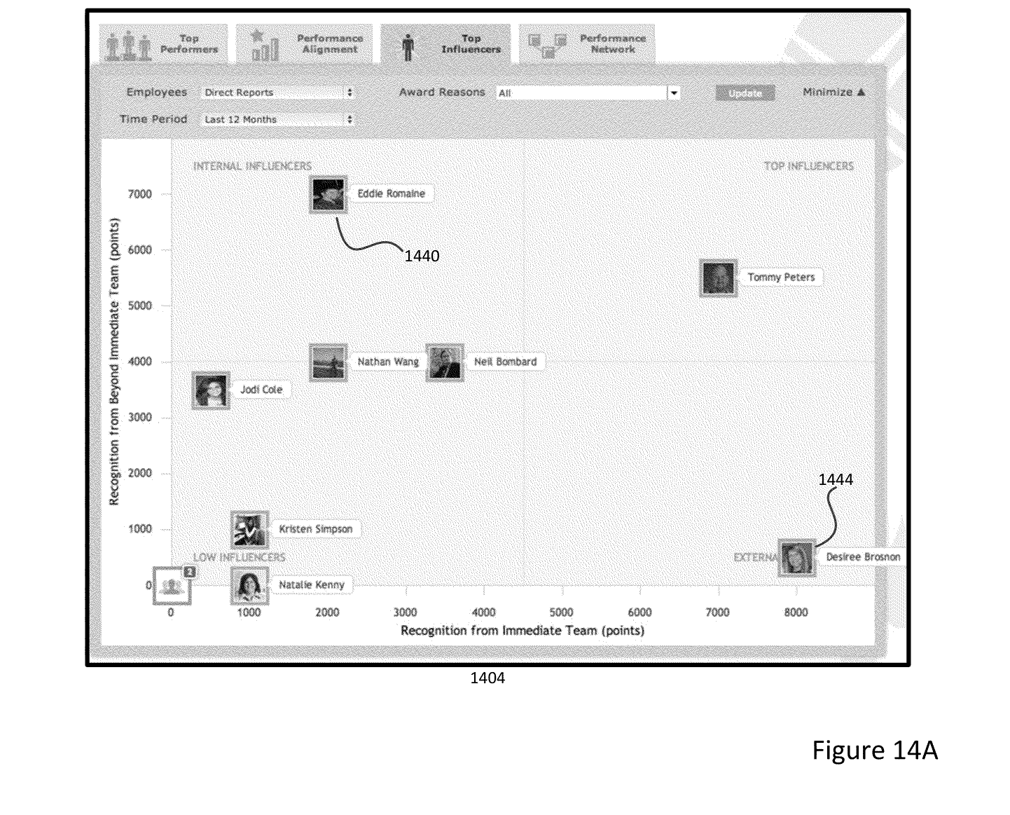

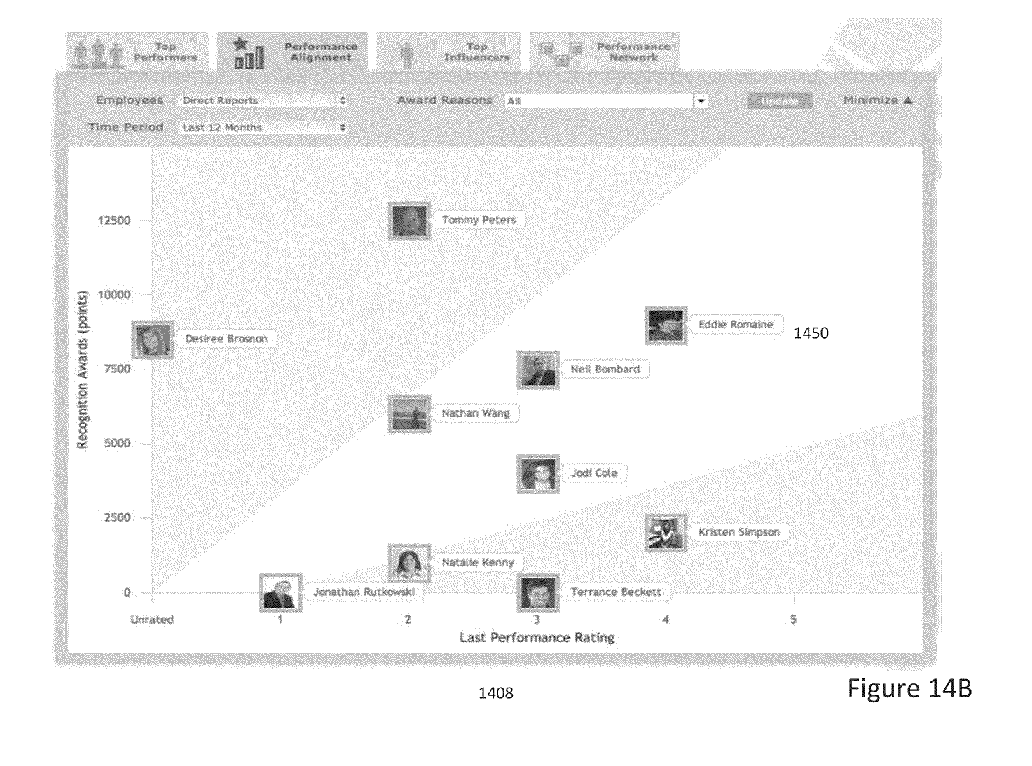

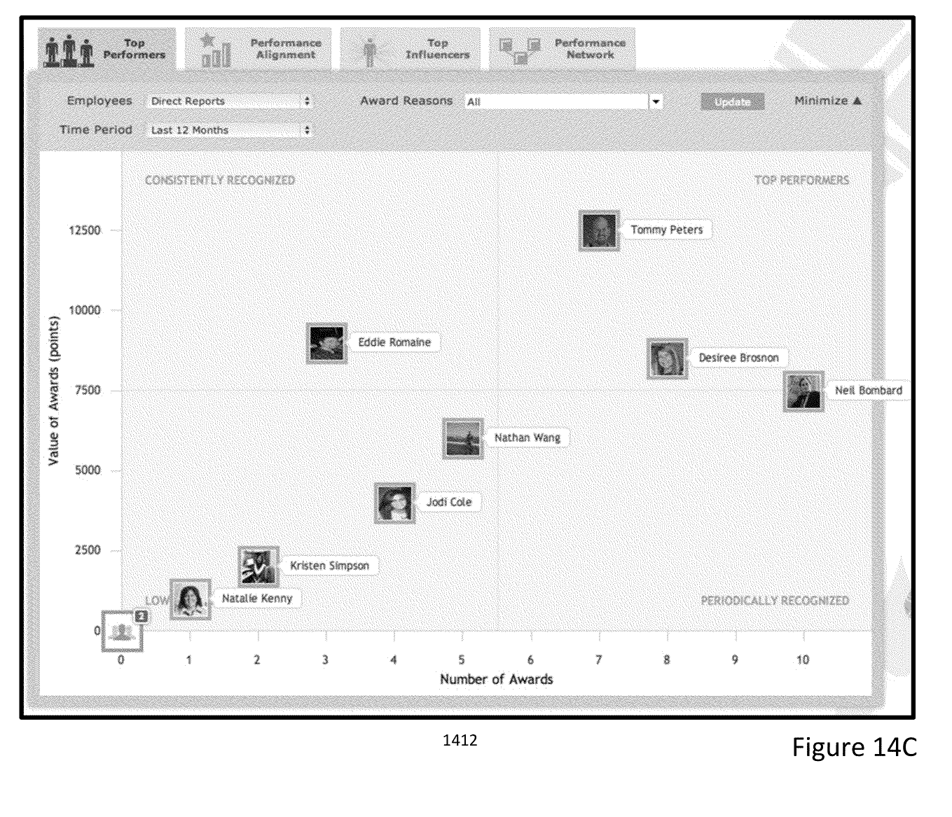

The recognition graph module 150 may generate an influence graph 1404 of FIG. 14A, a depiction of the relative “influence” of individuals of organization, based on the recognition they receive within and without their “group.” Each individual's network graph, which includes an aggregation of the details associated with recognition moments provided to that user, may be used as a proxy to determine the individual's relative influence. The influence graph 1404 may be generated based on two or more recognition details including, the amount of recognition moments, the source of the recognition, the performance rating associated with the recognition, last performance rating and other recognition data that may be collected by the data collection module 120. The sources of the recognition (i.e., the creators of the recognition moments) may be in two groups: internal to the individual's group (e.g., department), or external to the individual's group.

Thus, in one embodiment, an individual's location (i.e., coordinates) within the influence graph 1404 may be determined according to the number of recognition moments from each source. For example, Eddie (node 1440) may have received more recognition moments from those external to the group than Desiree (node 1444); but Desiree may have received more recognition moments from those within the group. The performance rating may be color coded, thereby allowing a user of the influence graph to perform a relative comparison between influence and performance quality. Employee attributes, other than performance ratings, may be selected for color coding, for example, flight risk, departure impact, potential and high performance. In at least one embodiment of the present invention, recognitions may also be received external to that of the company including by clients, by employees of partner companies, and others. In such embodiments, employee external recognition as depicted in influence/performance graph 1404 may include recognitions received from such external sources as well.

The recognition graph module 150 may also generate a performance alignment graph 1408, as depicted in FIG. 14B, that provides to managers information of how employee performance ratings align with recognitions received by each employee. Thus, a performance alignment graph, in one axis, may graph the performance rating of the employee, as determined from his or her performance reviews (e.g., last bi-annual or annual performance review). Each employee performance rating may be determined according to a predetermined and/or normalized performance review rating. Where there are employees across countries or teams, data may also be normalized accordingly so as to improve the quality of comparisons. In addition, the performance alignment graph may include a second axis that graphs employee quality of recognitions. Accordingly, the performance alignment graph may illustrate how employees with the greatest alignment between their performance rating and the recognition received via the recognition system 100. As illustrated in FIG. 14B, nodes that appear in an area 1450, appearing from the bottom left corner to the top right corner of the graph, may be considered to be aligned. That is, employees that are within this area 1450 contain performance ratings that are aligned with the recognition received from the recognition system. Employees outside of the area 1450, thus, may have gotten a better performance rating relative to his or her recognitions, and vice versa. Managers, for example may analyze such misaligned employee performance reviews and recognitions to further improve performance reviews, recognitions, and/or other aspects of the company.

In one embodiment, the recognition graph module 150 may generate one or more performance graphs that depict the top performers of a manager's team, set of teams, or of the company. The performance graphs may provide to managers details of the employee performance within the organization. For instance, the graphs may display the recognition performance with respect to each employee. As another example, shown in FIG. 14C, a generated performance graph 1412 may contain two axes: one axis reflecting the number of recognition awards each employee has received and another axis representing the total award value of the recognitions (e.g., total number of points received) that each employee has received. Thus, managers may easily recognize top employees who have received the greatest total recognition values (e.g., as measured by economic value) as well as the total number of recognitions, and conversely, those who are performing poorly by receiving few awards and/or minimal quality of recognitions. At the same time, the performance graph may allow managers to quickly and easily recognize employees who may receive a lot of recognition but not many quality recognitions, and vice versa. This may allow the manager to figure out issues that the employee or team may be having with the employee and/or identify other issues.

It should be understood that the graphs generated by the recognition graphing module might contain different sets of data (e.g., different categorization of what is considered internal or external) or additional categories of data (e.g., a category for internal to team, external to team, and external to the company). A manager or administrator may define the axis of a graph to be generated along with the nodes that are included within the graphs (e.g., the employees shown on the influence graph, award reasons, etc.). Indeed, more than two categories of data may be utilized to generate multi-dimensional graphs. For example, three categories of data may be utilized to generate a three-dimensional influence graph. The user may rotate, pan, zoom, and otherwise navigate the graphs and select each employee for more information. Furthermore, the nodes and other components of the graph may correspond to the employee and recognition data. For example, just as with the nodes of the recognition network graph, the shape, size and color of the nodes in these graphs may also correspond to employee and recognition data. In addition, just as with the recognition network graphs generated by the recognition graph module, the shape, size, pattern or other visual parameters of the components of these graphs may be customized and/or changed in accordance with various recognition and/or organizational data.

Those of ordinary skill in the art will recognize that other employee attributes could be added to the influence chart and still be consistent with the present invention.

### Talent Analysis

FIG. 15 illustrates another employee recognition system 1500, according to an exemplary embodiment of the invention, including an application module 1510, a client device 1570, and a network 1560. The application module 1150 may include a storage module 1580, recognition data collection module 1520, a recognition moment creation module 1530, recognition delivery module 1540, and recognition graph module 1550, each of which may operate in similar fashion to the respective modules of application module 110 (FIG. 1). In addition, the application module 1510 may include talent analysis module 1590 that enables managers or administrators to assess and manage their direct and indirect reports. In a preferred embodiment, the talent analysis module 1590 gives all managers and executives valuable recognition data to go beyond the performance review of employee performance, including data related to employee efforts that align or support corporate values.

Embodiments of the talent analysis module allow managers and administrators to define employees that are part of their team and view data of each direct or indirect report. In one embodiment, the talent analysis module 1590, in conjunction with the application module 1510, may automatically populate the team members for a manager by connecting to one or more computer systems of the company.

The talent analysis module 1590 may automatically gather, analyze, and generate team member performance and recognition data and may generate a plurality of user-interfaces to present the data to a manager in an easy to understand manner. For example, the talent analysis module 1590 may generate the user interfaces by collecting and analyzing the data stored at the storage module 1580, which may include the recognition data collected previously and/or in real-time by the data collection module 1520, the recognitions created by the recognition creation module 1530, the comments and messages received related to recognition, and other information received internally and externally to the company system(s) (e.g., social networks, HR databases, and others).

The employee data depicted may be illustrated in an easy to read manner, and may be in the form of infographics, historical data analysis graphs and other types of multimedia for easy understanding. A user may manipulate the data that is displayed by interacting with the user interface. The user may, for example, filter the data shown based on employee, company or recognition attributes. The user may further cause one or more data analysis functions of the talent analysis module to be executed, which may perform more in-depth data analysis, which may include predictive algorithms. In one embodiment, the talent analysis module dynamically generates a video of infographics customized for a team member, presenting all information selected by the manager for review. From such user interfaces generated by the talent analysis module, a user may receive modification and improvement suggestions by the talent analysis module 1590 with regard to a company's recognition system and may cause the employee recognitions system 1500 to perform the improvement or modification.

Managers may view each employee's history of recognition, nominations placed, congratulations expressed, and other information. Furthermore, managers may view the breakdown of each employee's recognition, including the recognitions based on types, nominators, levels of recognitions, awards, strengths, frequency, and other information. Additionally, each employee's recognition may be compared with that of other employees. Thus, managers may be presented with how each employee's recognition compares to other employees on his or her team, others with similar stature, others within the company, and others in the world across all companies. Managers may easily recognize whether an employee is being recognized more than other employees on his/her team or are receiving less quality recognition than others in the company (e.g., as compared to others that are paid the same or with the company for the same number of years). Examples of data viewable include awards year-to-date, awards across time, awards by group and level, awards by reason, awards by geography, awards by organization, and awards between geographies and organizations. Managers may filter and customize recognition reports based on date, country, approver, nominator, recipient and various other data attributes.

In at least one embodiment, an employee's recognition data may be compared to his/her performance reports generated by the company in the ordinary course (annually, bi-annually, quarterly and so on). Thus, managers may view the underlying data of an employee's performance alignment as compared to other employees, just as the manager may view an employee's performance alignment graph.

Furthermore, the talent analysis module 1590 may utilize one or more statistical analysis algorithms and predictive analytics techniques, such as neural network models and multiple linear regression, in order to generate reports describing important employee metrics. Such generated data may describe: the likelihood of an employee leaving the company; the performance potential of a company in the short and long run; the engagement of the employee with respect to his or her position, responsibility, team and the company; the actual or potential scope of influence within or outside of his or her team; employee connection score; succession candidacy; readiness for promotion; most inspirational employees; top performers; top culture promoter; top influencers, and other useful information.

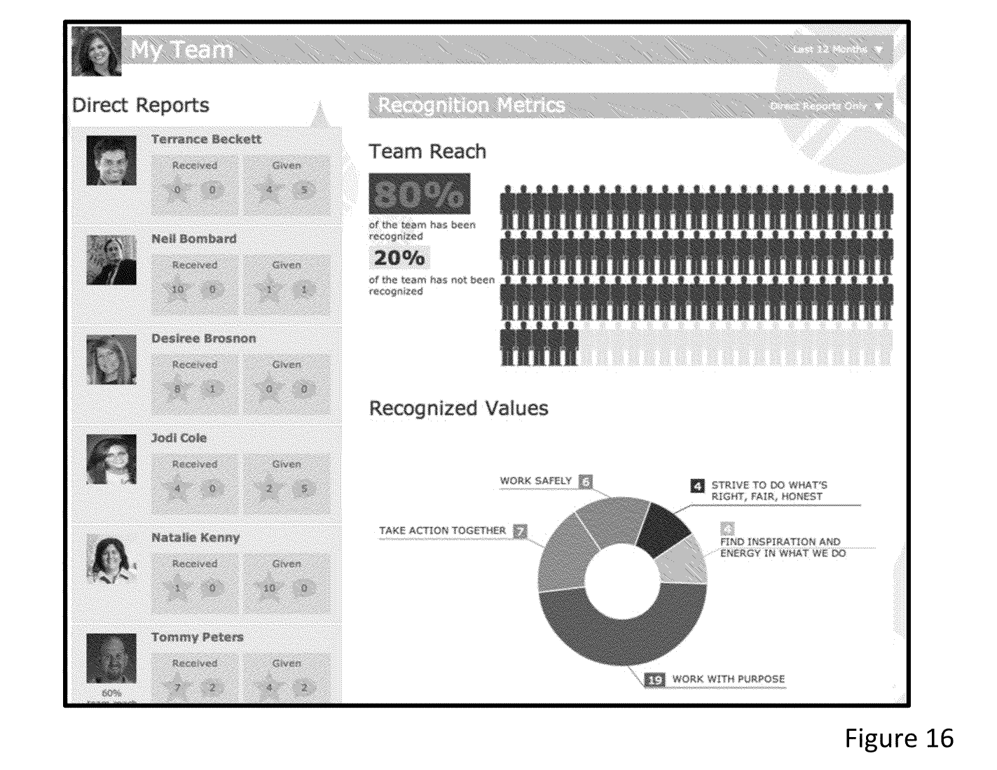

In one preferred embodiment of the present invention, talent analysis module 1590 further causes the generation of one or more monthly, quarterly, or annual reports that visually identify top performance, assess the adoption of corporate values, track critical cross-department interaction to determine collaboration effectiveness, identify trends, examine reach within key talent groups such as those employees with high potentials, flight risks, succession candidates, and other information. Such reports may be delivered to managers, executives, shareholders and others and enable recipients to recognize valuable employees and teams while identifying shortcomings and other aspects of the company. Just as with information available to team managers describe above, data may be depicted in easy to understand color infographics and/or other forms of multimedia, such as that depicted in FIG. 16.

As briefly discussed above, the computer systems disclosed herein, may include a general purpose computing device in the form of a computer including a processing unit, a system memory, and a system bus that couples various system components including the system memory to the processing unit. Computers typically include a variety of computer readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by a processing unit. The data or program modules may include an operating system, application programs, other program modules, and program data. The operating system may be or include a variety of operating systems such as Microsoft Windows® operating system, the Unix operating system, the Linux operating system, the Xenix operating system, the IBM AIX™ operating system, the Hewlett Packard UX™ operating system, the Novell Netware™ operating system, the Sun Microsystems Solaris™ operating system, the OS/2™ operating system, the BeOS™ operating system, the Macintosh™® operating system, the Apache™ operating system, an OpenStep™ operating system or another operating system or platform.

At a minimum, the memory includes at least one set of instructions that is either permanently or temporarily stored. The processor executes the instructions that are stored in order to process data. The set of instructions may include various instructions that perform a particular task or tasks, such as those shown in the appended flowcharts. Such a set of instructions for performing a particular task may be characterized as a program, software program, software, engine, module, component, mechanism, or tool. The system may include a plurality of software processing modules stored in a memory as described above and executed on a processor in the manner described herein. The program modules may be in the form of any suitable programming language, which is converted to machine language or object code to allow the processor or processors to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments of the invention. Illustratively, the programming language used may include assembly language, Ada, APL, Basic, C, C++, COBOL, dBase, Forth, FORTRAN, Java, Modula-2, Pascal, PHP, Prolog, Python, REXX, and/or JavaScript, for example. Further, it is not necessary that a single type of instruction or programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module.

The computing environment may also include other removable/non-removable, volatile/nonvolatile computer storage media. For example, a hard disk drive may read or write to non-removable, nonvolatile magnetic media. A magnetic disk drive may read from or write to a removable, nonvolatile magnetic disk, and an optical disk drive may read from or write to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media is typically connected to the system bus through a removable or non-removable memory interface.

It should be appreciated that the processors and/or memories of the computer system need not be physically in the same location. Each of the processors and each of the memories used by the computer system may be in geographically distinct locations and be connected so as to communicate with each other in any suitable manner. Additionally, it is appreciated that each processor and/or memory may be composed of different physical pieces of equipment.

A participant may enter commands and information into the computer through a user interface that includes input devices such as a keyboard and pointing device, commonly referred to as a mouse, trackball or touch pad. Other input devices may include a microphone, joystick, game pad, satellite dish, scanner, voice recognition device, keyboard, touch screen, toggle switch, pushbutton, or the like. These and other input devices are often connected to the processing unit through a participant input interface that is coupled to the system bus, but may be connected by other interface and bus structures, such as a parallel port, game port or a universal serial bus (USB).

One or more monitors or display devices may also be connected to the system bus via an interface. In addition to display devices, computers may also include other peripheral output devices, which may be connected through an output peripheral interface. The computers implementing the invention may operate in a networked environment using logical connections to one or more remote computers, the remote computers typically including many or all of the elements described above.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made expressly herein, without departing from the spirit and scope of the invention. In fact, variations, modifications, and other implementations of what was described herein will occur to those of ordinary skill in the art without departing from the spirit and the scope of the invention. In particular, it should be understood that the order of steps or order for performing certain actions is immaterial so long as the invention remains operable. Two or more steps or actions may also be conducted simultaneously. As such, the invention is not to be defined only by the preceding illustrative description.

From the foregoing, it will be seen that this invention is one well adapted to attain all the ends and objects set forth above, together with other advantages, which are obvious and inherent to the systems and methods. It will be understood that certain features and sub-combinations are of utility and may be employed without reference to other features and sub-combinations. This is contemplated and within the scope of the invention.

1. A system for promoting employee recognition at an organization, the system comprising:
a recognition data collection module for:
receiving organizational data of the organization, the organizational data including at least organizational relationship data of a plurality of employees;
receiving recognition details associated with one or more recognition moments;
storing in memory the recognition details and the organizational data; and
a recognition graph module for generating, using at least one processor, a recognition network graph based on at least the recognition details and the organizational data containing the organizational relationship data, wherein the generated recognition network graph contains a plurality of nodes representing the plurality of employees.

2. The system of claim 1, wherein the recognition graph module aggregates at least the recognition details and the organizational data to generate the recognition network graph.

3. The system of claim 1, wherein the recognition graph module associates a first node and a second node with at least one recognition moment and at least a portion of the organizational data, the second node connected to the first node by a graphical link.

4. The system of claim 3, wherein the graphical link represents at least one of recognition moments received by a first employee from a second employee and recognition moments received by the second employee from the first employee.

5. The system of claim 3, wherein the graphical link corresponds to the stored recognition details.

6. The system of claim 3, wherein the recognition data collection module determines an employee connection score based on the recognition details and organizational data.

7. The system of claim 6, wherein the shape, size or color of the first node is based on at least the determined employee connection score.

8. The system of claim 6, wherein the shape, thickness or color of the graphical link is based on at least on the determined employee connection score.

9. The system of claim 1, wherein the recognition network graph contains a focus node representing a first employee, the focus node being located at a general center location of the recognition network graph and connected to a plurality of connected nodes by a plurality of graphical links in accordance with at least the recognition details and the organizational data.

10. The system of claim 9, wherein, in response to a selection of a second employee, the recognition graph module generates a second recognition network graph containing a second focus node located at a general center location of the second recognition network graph, the second focus node representing the second employee.

11. The system of claim 1, wherein the recognition graph module generates a performance graph, the performance graph depicting employee performance of at least some of the plurality of employees.

12. The system of claim 11, wherein the performance graph is generated based on at least one of: a determined employee connection score, the number of recognition moments for each employee, and an economic value of recognition moments.

13. The system of claim 1, wherein the recognition graph module generates an influence graph, the influence graph depicting the relative organizational influence of at least some of the plurality of employees of the organization.

14. The system of claim 13, wherein the influence graph is generated based on at least one of the following recognition details:
number of recognition moments;
source of the recognition moments;
employee connection score; and
employee performance rating.

15. The system of claim 13, wherein the influence graph contains a first node representing a first employee on a first team, and the position of a first node within the influence graph is based on recognition details including:
an internal employee connection score calculated using the recognition moments associated with the first employee and employees part of the first team; and
an external employee connection score calculated based on recognition moments associated with the first employee and employees not part of the first team.

16. The system of claim 1, wherein the recognition graph module generates a performance alignment graph, the performance alignment graph depicting the alignment of the recognition moments against performance ratings associated with performance reviews for at least some of the plurality of employees.

17. The system of claim 16, wherein the performance alignment graph contains a first node representing a first employee, and the position of the first node within the performance alignment graph is based on at least a recognition connection score and a performance review rating of the first employee.

18. The system of claim 1, wherein the recognition details comprise one or more of a creator, a recipient, an award, an award reason, a role relationship, a performance indicator, a scope of accomplishment, a recognition category, a message; recognition reason data; recognition nominator data; recognition nominee data; recognition profile and activities data; sphere of influence data; validation data; composition of recognition message data; approval data; and recognition distribution data.

19. The system of claim 1, wherein the recognition graph module is further configured to automatically regenerate the recognition network graph in response to the data collection module receiving new recognition details associated with new recognition moments, the recognition graph module regenerating the recognition network graph based on the new recognition details.

20. The system of claim 1, further comprising a recognition delivery module configured to automatically transmit the recognition details to one or more computing devices upon the receiving of the recognition details by the recognition data collection module, wherein the transmitting causes at least some of the recognition details to be automatically displayed at the one or more computing devices.

21. The system of claim 1, further comprising a talent analysis module configured to:
automatically process, using the at least one processor, the recognition details and the organizational data to generate recognition analytics results;
determine employees part of a manager's team; and
generate a talent analysis user interface containing the generated recognition analytics results associated with the employees part of the manager's team.

22. The system of claim 21, wherein the generated recognition analytics results describing at least one of:
likelihood of an employee leaving the company;
work engagement;
employee connections;
performance potential;
scope of influence;
employee engagement;
employee connection score;
succession candidacy;
readiness for promotion;
most inspirational employees;
top performers;
top culture promoter; and
top influencers.

23. The system of claim 1, wherein the organizational data comprises at least one of:
team and division data;
tenure data;
diversity data;
performance rating data;
employee history data;
grade and grade history data; and
functional group data.

24. A computer-implemented method for promoting employee recognition at an organization, the method comprising:
performing the following operations at one or more computers comprising a memory and a processor:
receiving organizational data of the organization, the organizational data including at least organizational relationship data of a plurality of employees;
receiving recognition details associated with one or more recognition moments;
storing in memory the recognition details and the organizational data; and
generating a recognition network graph based on at least the recognition details and the organizational data containing the organizational relationship data, wherein the generated recognition network graph contains a plurality of nodes representing the plurality of employees.

25. The method of claim 24, further comprising the step of aggregating at least the recognition details and the organizational data, wherein the recognition network graph is generated based on said aggregating.

26. The method of claim 24, further comprising the step of associating a first node and a second node with at least one recognition moment and at least a portion of the organizational data, the second node connected to the first node by a graphical link.

27. The method of claim 26, wherein the graphical link represents at least one of recognition moments received by a first employee from a second employee and recognition moments received by the second employee from the first employee.

28. The method of claim 26, wherein the graphical link corresponds to the stored recognition details.

29. The method of claim 26, further comprising the step of determining an employee connection score based on the recognition details and organizational data.

30. The method of claim 29, wherein the shape, size or color of the first node is based on at least the determined employee connection score.

31. The method of claim 29, wherein the shape, thickness or color of the graphical link is based on at least the determined employee connection score.

32. The method of claim 24, wherein the recognition network graph contains a focus node representing a first employee, the focus node being located at a general center location of the recognition network graph and connected to a plurality of connected nodes by a plurality of graphical links in accordance with at least the recognition details and the organizational data.

33. The method of claim 32, wherein in response to the selection of a second employee, the recognition graph module generates a second recognition network graph containing a second focus node located at a general center location of the second recognition network graph, the second focus node representing the second employee.

34. The method of claim 24, further comprising the step of generating at least one of the following:
a performance graph depicting employee performance of at least some of the plurality of employees;
an influence graph depicting the relative organizational influence of at least some of the plurality of employees; and
a performance alignment graph depicting the alignment of the recognition moments against performance ratings associated with performance reviews for at least some of the plurality of employees.

35. The method of claim 34, wherein the performance graph is generated based at least one of: a determined employee connection score, the number of recognition moments for each employee, and an economic value of recognition moments.

36. The method of claim 34, wherein the influence graph is generated based on at least one of the following recognition details:
number of recognition moments;
source of the recognition moments;
employee connection score; and
employee performance rating.

37. The method of claim 34, wherein the influence graph contains a first node representing a first employee on a first team, and the position of a first node within the influence graph is based on recognition details including:
an internal employee connection score calculated using the recognition moments associated with the first employee and employees part of the first team; and
an external employee connection score calculated based on recognition moments associated with the first employee and employees not part of the first team.

38. The method of claim 34, wherein the performance alignment graph contains a first node representing a first employee, and the position of a first node within the performance alignment graph is based on at least a recognition connection score and a performance review rating of the first employee.

39. The method of claim 24, wherein the recognition details comprise one or more of a creator, a recipient, an award, an award reason, a role relationship, a performance indicator, a scope of accomplishment, a recognition category, a message; recognition reason data; recognition nominator data; recognition nominee data; recognition profile and activities data; sphere of influence data; validation data; composition of recognition message data; approval data; and recognition distribution data.

40. The method of claim 24, wherein the recognition graph module is further configured to automatically regenerate the recognition network graph in response to receiving new recognition details associated with new recognition moments, the recognition graph module regenerating the recognition network graph based on the new recognition details.

41. The method of claim 24, further comprising the step of automatically transmitting the recognition details to one or more computing devices upon the receiving of the recognition details, wherein the transmitting causes at least some of the recognition details to be automatically displayed at the one or more computing devices.

42. The method of claim 24, further comprising the steps of:
automatically processing the recognition details and the organizational data to generate recognition analytics results;
determining employees part of a manager's team; and
generating a talent analysis user interface containing the generated recognition analytics results associated with the employees part of the manager's team.

43. The method of claim 24, wherein the organizational data comprises at least one of:
team and division data;
tenure data;
diversity data;
performance rating data;
employee history data;
grade and grade history data; and
functional group data.

44. A computer-implemented method for promoting employee recognition at an organization, the method comprising:
performing the following operations at one or more computers comprising a memory and a processor:
receiving organizational data of the organization, the organizational data including at least organizational relationship data of a plurality of employees;
receiving recognition details associated with one or more recognition moments;
automatically transmitting the recognition moments to a client device upon the receiving of the recognition details for display in a recognition feed to a user;
discarding a portion of the plurality of recognition feeds; and
presenting an un-discarded portion of the plurality of recognition feeds.

45. The method of claim 44, wherein discarding the portion of the plurality of recognition feeds comprises comparing the recognition feeds to a watch list.

46. The method of claim 45, further comprising, adding an entry to the watch list based on a recognition network graph.

47. The method of claim 46, wherein said entry is added to the watch list based on the recognitions received from or provided to another user in accordance with at least one recognition feed.

48. The method of claim 45, further comprising, adding an entry to the watch list based on a selection by the user.
